(19) United States
(12) Patent Application Publication
(10) Pub. No.: US 2021/0341123 A1
(43) Pub. Date: Nov. 4, 2021

(54) VEHICLE LAMP

(71) Applicant: KOITO MANUFACTURING CO., LTD., Tokyo (JP)

(72) Inventor: Ayaka MOTOTSUJI, Shizuoka (JP)

(73) Assignee: KOITO MANUFACTURING CO., LTD., Tokyo (JP)

(21) Appl. No.: 17/282,225

(22) PCT Filed: Oct. 2, 2019
(86) PCT No.: PCT/JP2019/038880

§ 371 Date: Apr. 1, 2021

(30) Foreign Application Priority Data
Oct. 5, 2018 (JP) 2018-190500
Oct. 5, 2018 (JP) 2018-190501
Oct. 5, 2018 (JP) 2018-190502
Nov. 2, 2018 (JP) 2018-207297

(51) Int. Cl. F21S 41/265; F21S 41/40; F21S 41/20; F21S 41/143; F21S 41/32

(52) U.S. Cl. CPC F21S 41/265; F21S 41/40; F21S 41/322; F21S 41/143; F21S 41/28; F21S 41/285

(57) ABSTRACT

A vehicle lamp is configured to form a required light distribution pattern by irradiating light emitted from a light source unit toward a lamp front side via a microlens array. The microlens array is configured such that a plurality of condenser lens portions configured to converge the light emitted from the light source unit are formed on a rear surface, while a plurality of projection lens portions configured to project a plurality of light source images formed by the plurality of condenser lens portions are formed on a front surface, and a laterally long light distribution pattern is formed by the light emitted from the microlens array.

### TECHNICAL FIELD

The present disclosure relates to a vehicle lamp including a microlens array.

### BACKGROUND ART

In related art, there is known a projection type display device configured to irradiate light emitted from a light source unit toward a device front side via a microlens array.

“Patent Literature 1” describes a microlens array of such a projection type display device, which includes a rear lens array in which a plurality of condenser lens portions configured to converge light emitted from a light source unit are formed on a rear surface, and a front lens array in which a plurality of projection lens portions configured to project a plurality of light source images formed by the plurality of condenser lens portions are formed on a front surface.

The projection type display device described in “Patent Literature 1” is configured to display the light source image whose shape is defined by a plurality of imaging structures arranged between the rear lens array and the front lens array on a screen arranged on the device front side.

Meanwhile, “Patent Literature 2” describes a vehicle lamp configured to form a required light distribution pattern by irradiating light emitted from a light source unit toward a lamp front side via a microlens array.

According to the vehicle lamp described in “Patent Literature 2”, a light shielding plate configured to define a shape of each of a plurality of light source images formed by a plurality of condenser lens portions is arranged between the rear lens array and the front lens array, and thus a light distribution pattern whose upper portion has a cut-off line is formed as the required light distribution pattern.

### CITATION LIST

### Patent Literature

Patent Literature 1: Japanese Patent No. 5327658

Patent Literature 2: Japanese Patent No. 6229054

### SUMMARY OF INVENTION

### Technical Problem

It is preferable that the vehicle lamp forms a laterally long light distribution pattern as the required light distribution pattern from the viewpoint of widely illuminating a traveling path on a vehicle front side.

According to the vehicle lamp described in “Patent Literature 2”, by appropriately defining the shape of each of the plurality of light source images by the light shielding plate, it is possible to form the laterally long light distribution pattern as the required light distribution pattern.

However, in the case where the laterally long light distribution pattern is formed by using such a light shielding plate, light shielded by the light shielding plate is wasted, and thus a light source light flux cannot be effectively used.

A first object of the present disclosure is to provide a vehicle lamp including a microlens array, which can form a laterally long light distribution pattern while effectively using a light source light flux.

According to the vehicle lamp described in “Patent Literature 2”, since the shape of each of the plurality of light source images formed by the plurality of condenser lens portions is unchangeably defined by the light shielding plate, the shape and brightness of the light distribution pattern whose upper portion has the cut-off line cannot be changed in accordance with a vehicle traveling situation or the like.

Such a problem can similarly occur in a case where a light distribution pattern, in which the cut-off line is provided at a portion other than the upper portion, is formed.

A second object of the present disclosure is to provide a vehicle lamp including a microlens array, which can change a shape and brightness of a light distribution pattern in accordance with a vehicle traveling situation or the like.

From the viewpoint of traffic safety, it is also desirable that the vehicle lamp forms, as the required light distribution pattern, a light distribution pattern for road surface drawing (that is, a light distribution pattern that draws a symbol, a pattern, or the like on a road surface around a vehicle so as to attract attention to surroundings) in addition to a normal light distribution pattern such as a low-beam light distribution pattern or a high-beam light distribution pattern.

Although it is desirable that the vehicle lamp which includes the microlens array is configured to form the light distribution pattern for road surface drawing, it is desirable that a lamp configuration thereof is simplified as much as possible while the function of attracting attention to the surroundings is improved.

A third object of the present disclosure is to provide a vehicle lamp including a microlens array, which can form, by a simple lamp configuration, a light distribution pattern for road surface drawing whose function of attracting attention to surroundings is excellent.

According to the vehicle lamp described in “Patent Literature 2”, the microlens array has a configuration in which an optical axis of each of the plurality of condenser lens portions formed in the rear lens array and an optical axis of each of the plurality of projection lens portions formed in the front lens array coincide with each other.

Therefore, in the case of forming the light distribution pattern whose upper portion has the cut-off line, a proportion of light shielded by the light shielding plate to the light which is emitted from the light source unit and incident on the rear lens array is large, and thus the light source light flux cannot be effectively used. Therefore, the brightness of the light distribution pattern cannot be sufficiently ensured.

Such a problem can similarly occur in the case where the light distribution pattern in which the cut-off line is provided at the portion other than the upper portion, is formed.

A fourth object of the present disclosure is to provide a vehicle lamp including a microlens array, which can sufficiently ensure brightness of a light distribution pattern even when a light distribution pattern having a cut-off line is formed.

### Solution to Problem

The present disclosure achieves the first to fourth objects by the following configurations.

In order to achieve the first object, a vehicle lamp according to an first aspect of the present disclosure is

a vehicle lamp configured to form a required light distribution pattern by irradiating light emitted from a light source unit toward a Lamp front side via a microlens array.

The microlens array is configured such that a plurality of condenser lens portions configured to converge the light emitted from the light source unit are formed on a rear surface, while a plurality of projection lens portions configured to project a plurality of light source images formed by the plurality of condenser lens portions are formed on a front surface. A laterally long light distribution pattern is formed by the light emitted from the microlens array.

A specific configuration of the “microlens array” is not particularly limited as long as the laterally long light distribution pattern is formed by the light emitted from the microlens array.

The vehicle lamp according to the first aspect of the present disclosure is configured to form the required light distribution pattern by irradiating the light emitted from the light source unit toward the lamp front side via the microlens array. Since the microlens array is configured to form the laterally long light distribution pattern by the emitted light thereof, the laterally long light distribution pattern can be formed without using any light shielding plate. Therefore, light shielded by the light shielding plate is not wasted, and thus a light source light flux can be effectively used.

Moreover, according to the present disclosure, a configuration of the lamp can be simplified since no light shielding plate is used.

In the above configuration, if the microlens array further includes a region in which a curvature of a surface of the condenser lens portion and/or the projection lens portion is set to different values in a horizontal plane and in a vertical plane, for example, a left-right direction diffusion angle of the light emitted from the microlens array can easily become larger than an up-down direction diffusion angle in such a region.

In the above configuration, if the microlens array further includes a region in which a curvature in a horizontal plane of a surface of the condenser lens portion and a curvature in a horizontal plane of a surface of the projection lens portion corresponding to the condenser lens portion are set to different values, for example, the left-right direction diffusion angle of the light emitted from the microlens array can easily became larger than the up-down direction diffusion angle in such a region.

In the above configuration, if the microlens array further includes a region in which a horizontal cross-sectional shape of a surface of the projection lens portion has a concave curved shape, for example the left right direction diffusion angle of the light emitted from the microlens array can easily become significantly larger than the up-down direction diffusion angle in such a region.

In the above configuration, if the microlens array further includes a region configured to cause incident light from the condenser lens portion to be incident on projection lens portions adjacent to left and right sides of the projection lens portion corresponding to the condenser lens portion, for example, it is possible to increase the left-right direction diffusion angle of the light emitted from the adjacent projection lens portions on the left and right sides, and thus it is possible to easily form the laterally long light distribution pattern.

In the above configuration, if the microlens array includes a region in which outer shapes of the condenser lens portion and the projection lens portion corresponding to the condenser lens portion are set to a vertically long rectangular shape in a lamp front view, for example, the left-right direction diffusion angle of the light emitted from the microlens array can easily become larger than the up-down direction diffusion angle in such a region, and at this time, it is also possible to easily cause the incident light from the condenser lens portion to be incident on the projection lens portions adjacent to the left and right sides of the projection lens portion corresponding to the condenser lens portion.

In order to achieve the second object a vehicle lamp according to a second aspect of the present disclosure is

a vehicle lamp configured to form a required light distribution pattern by irradiating light emitted from a light source unit toward a lamp front side via a microlens array.

The microlens array includes a rear lens array in which a plurality of condenser lens portions configured to converge the light emitted from the light source unit are formed an a rear surface, and a front lens array in which a plurality of projection lens portions configured to project a plurality of light source images formed by the plurality of condenser lens portions are formed on a front surface.

A spatial light modulator is arranged between the rear lens array and the front lens array, the spatial light modulator being configured to control a spatial distribution of light that passes through the rear lens array and is incident on the front lens array.

A specific configuration of the “spatial light modulator” is not particularly limited as long as the spatial light modulator can control the spatial distribution of the light that passes through the rear lens array and is incident on the front lens array. For example, a spatial light modulator using a light transmissive liquid crystal or using an OLED can be adopted.

The vehicle lamp according to the second aspect of the present disclosure is configured to form the required light distribution pattern by irradiating the light emitted from the light source unit toward the lamp front side via the microlens array Since the spatial light modulator which is configured to control the spatial distribution of the light that passes through the rear lens array and is incident on the front lens array is arranged between the rear lens array and the front lens array, a light distribution pattern having any shape and brightness as desired can be formed as the required light distribution pattern, and such shape and brightness can be changed over time.

According to the present disclosure, it is also possible to easily form a light distribution pattern having a cut-off line as the required light distribution pattern. At this time, the shape and brightness of the light distribution pattern can be changed in accordance with a vehicle traveling situation or the like.

In the above configuration, if the spatial light modulator is further arranged along a vertical plane passing a vicinity of a rear focus point of each projection lens portion constituting the front lens array, for example, the cut-off line can be formed clearly.

In the above configuration, if the spatial light modulator is further sandwiched by the front lens array and the rear lens array from two sides in a lamp front-rear direction, for example, positioning accuracy of the spatial light modulator can be improved, and a lamp configuration can be simplified.

In the above configuration, if the rear lens array further includes a region in which a front focus point of the condenser lens portion is offset to a lamp front side relative to the rear focus point of the projection lens portion corresponding to the condenser lens portion, for example, a relatively large light source image is formed by the light which is emitted from the light source unit and incident on the rear lens array in such a region on a rear focal plane of the projection lens portion, and thus a size of the light distribution pattern can be increased.

In order to achieve the third object, a vehicle lamp according to a third aspect of the present disclosure is

a vehicle lamp configured to form a required light distribution pattern by irradiating light emitted from a light source unit toward a Lamp front side via a microlens array.

The microlens array includes a rear lens array in which a plurality of condenser lens portions configured to converge the light emitted from the light source unit are formed on a rear surface, and a front lens array in which a plurality of projection lens portions configured to project a plurality of light source images formed by the plurality of condenser lens portions are formed on a front surface.

A light shielding plate configured to define a shape of each of the plurality of light source images and a color filter configured to change a color of the light emitted from the microlens array to a color different from a color of the light emitted from the light source unit are arranged between the rear lens array and the front lens array.

A specific shape, arrangement, and the like of the “light shielding plate” are not particularly limited as long as the light shielding plate is configured to define the shape of each of the plurality of light source images so as to form a light distribution pattern for road surface drawing as the required light distribution pattern.

A specific configuration of the “color filter” is not particularly limited as long as the color filter can change the color of the light emitted from the microlens array to the color different from the color of the light emitted from the light source unit, and a specific color of the “color different from the color of the light emitted from the light source unit” is not particularly limited.

The vehicle lamp according to the third aspect of the present disclosure is configured to form the required light distribution pattern by irradiating the light emitted from the light source unit toward the lamp front side via the microlens array. Since the light shielding plate configured to define the shape of each of the plurality of light source images formed by the plurality of condenser lens portions is arranged between the rear lens array and the front lens array constituting the microlens array, it is possible to appropriately set an opening shape of the light shielding plate so as to form the light distribution pattern for road surface drawing by the light emitted from the microlens array.

At this time, since the color filter configured to change the color of the light emitted from the microlens array to the color different from the color of the light emitted from the light source unit is arranged between the rear lens array and the front lens array, the color filter can form the light distribution pattern for road surface drawing in a color different from that of a normal light distribution pattern, and thus a function of attracting attention to the surroundings can be improved.

In the above configuration, if the color filter is further constituted by a color film attached to the light shielding plate, for example, a lamp configuration can be further simplified.

In the above configuration, if the light shielding plate and the color filter are further sandwiched by the front lens array and the rear lens array from two sides in a lamp front-rear direction, for example, positioning accuracy of the light shielding plate and the color filter can be improved, and the lamp configuration can be further simplified.

In the above configuration, if the rear lens array is configured such that an optical axis of the condenser lens portion is offset upward relative to an optical axis of the projection lens portion corresponding to the condenser lens portion, for example, most of the light emitted from the microlens array can be downward light, and thus the light distribution pattern for road surface drawing can be efficiently formed.

In the above configuration, if the rear lens array is configured such that a front focus point of the condenser lens portion is offset to the lamp front side relative to a rear focus point of the projection lens portion corresponding to the condenser lens portion, for example, a relatively large light source image can be fanned by the light which is emitted from the light source unit and incident on the rear lens array on a rear focal plane of the projection lens portion, and thus the light distribution pattern for road surface drawing can be easily formed with a required size.

In order to achieve the fourth object, a vehicle lamp according to a fourth aspect of the present disclosure is

a vehicle lamp configured to form a required light distribution pattern by irradiating light emitted from a light source unit toward a lamp front side via a microlens array.

The microlens array includes a rear lens array in which a plurality of condenser lens portions configured to converge the light emitted from the light source unit are formed on a rear surface, and a front lens array in which a plurality of projection lens portions configured to project a plurality of light source images formed by the plurality of condenser lens portions are formed on a front surface.

A light shielding plate configured to define a shape of each of the plurality of light source images is arranged between the rear lens array and the front lens array.

The rear lens array includes a region in which an optical axis of the condenser lens portion is offset relative to an optical axis of the projection lens portion corresponding to the condenser lens portion.

A specific shape, arrangement, and the like of the “light shielding plate” are not particularly limited as long as the light shielding plate is configured to define the shape of each of the plurality of light source images so as to form a light distribution pattern having a cut-off line as the required light distribution pattern.

Although the “rear lens array” includes the region in which the optical axis of the condenser lens portion is offset relative to the optical axis of the corresponding projection lens portion, a specific position, size, and the like of the region are not particularly limited. Moreover, a direction of the offset and a specific value of an amount of the offset are not particularly limited.

The vehicle lamp according to the fourth aspect of the present disclosure is configured to form the required light distribution pattern by irradiating the light emitted from the light source unit toward the lamp front side via the microlens array. Since the light shielding plate configured to define the shape of each of the plurality of light source images formed by the plurality of condenser lens portions is arranged between the rear lens array and the front lens array constituting the microlens array, the light distribution pattern having the cut-off line can be formed as the required light distribution pattern.

In addition, since the rear lens array includes the region in which the optical axis of the condenser lens portion is offset relative to the optical axis of the projection lens portion corresponding to the condenser lens portion, such a region can reduce a proportion of light shielded by the light shielding plate to the light which is emitted from the light source unit and incident on the rear lens array, and thus a light source light flux can be effectively used. Therefore, the light distribution pattern having the cut-off line can be formed with increased brightness while a position and a shape of the cut-off line are maintained.

At that time, if the rear lens array includes a region in which the optical axis of the condenser lens portion is offset upward relative to the optical axis of the projection lens portion corresponding to the condenser lens portion, for example, the brightness can be sufficiently ensured even in a case where a light distribution pattern whose upper portion has a cut-off line (for example, a low-beam light distribution pattern) is formed.

At that time, if the rear lens array further includes a plurality of regions in which amounts of upward offset of the optical axis of the condenser lens portion are different, for example, the light distribution pattern whose upper portion has the cut-off line can be formed as a combined light distribution pattern of a plurality of light distribution patterns whose lower end edge positions are different. As a result, the light distribution pattern whose upper portion has the cut-off line can be formed with less light distribution unevenness.

In the above configuration, if the rear lens array further includes a region in which the optical axis of the condenser lens portion is offset in a left-right direction relative to the optical axis of the projection lens portion corresponding to the condenser lens portion, for example the light distribution pattern having the cut-off line can be formed with increased left-right direction spread while the position and the shape of the cut-off line are maintained.

At that time, if the rear lens array includes a plurality of regions in which amounts of the left-right direction offset of the optical axis of the condenser lens portion are different, for example, the light distribution pattern having the cut-off line can be formed as a combined light distribution pattern of a plurality of light distribution patterns whose left-right direction positions are offset from each other. As a result, the light distribution pattern having the cut-off line can be formed with less light distribution unevenness.

In the above configuration, if the rear lens array further includes a region in which a front focus point of the condenser lens portion is offset to the lamp front side relative to a rear focus point of the projection lens portion corresponding to the condenser lens portion, for example, a relatively large light source image is formed by the light which is emitted from the light source unit and incident on the rear lens array in such a region on a rear focal plane of the projection lens portion, and thus a size of the light distribution pattern having the cut-off line can be increased.

### Advantageous Effects of Invention

According to the first aspect of the present disclosure, the vehicle lamp including the microlens array can form the laterally long light distribution pattern while effectively using the light source light flux.

According to the second aspect of the present disclosure, the vehicle lamp including the microlens array can change the shape and the brightness of the light distribution pattern in accordance with the vehicle traveling situation or the like.

According to the third aspect of the present disclosure, the vehicle lamp including the microlens array can form, by the simple lamp configuration, the light distribution pattern for road surface drawing whose function of attracting attention to the surroundings is excellent.

According to the fourth aspect of the present disclosure, the vehicle lamp including the microlens array can sufficiently ensure the brightness of the light distribution pattern even when the light distribution pattern having the cat-off line is formed.

### BRIEF DESCRIPTION OF DRAWINGS

FIG. 1 is a front view showing a vehicle lamp according to an embodiment of the present disclosure.

FIG. 2 is a cross sectional view taken along line II-II of FIG. 1.

FIG. 3 is a cross sectional view taken along line III-III of FIG. 1.

(a) of FIG. 4 is a detailed view of portion IVa shown in FIG. 2, (b) of FIG. 4 is a detailed view of portion IVb shown in FIG. 2, and (c) of FIG. 4 is a detailed view of portion IVc shown in FIG. 2.

(a) of FIG. 5 is a detailed view of portion Va shown in FIG. 3, and (b) and (c) of FIG. 5 show other portions in the same manner as (a) of FIG. 5.

FIG. 6 is a view taken in a direction of arrow VI of FIG. 4.

FIG. 7 transparently shows a light distribution pattern formed by light irradiated from the vehicle lamp.

FIG. 8A shows a main part of a vehicle lamp according to a first modification of the embodiment in the same manner as (a) of FIG. 4.

FIG. 8B shows a main part of a vehicle lamp according to a second modification of the embodiment in the same manner as (a) of FIG. 4.

FIG. 9A shows the main part of the vehicle lamp according to the first modification of the embodiment in the same manner as (a) of FIG. 6.

FIG. 9B shows the main part of the vehicle lamp according to the first modification of the embodiment in the same manner as (a) of FIG. 4.

FIG. 10 is a front view showing a vehicle lamp according to an embodiment of the present disclosure.

FIG. 11 is a cross sectional view taken along line II-II of FIG. 10.

FIG. 12 is a cross sectional view taken along line III-III of FIG. 10.

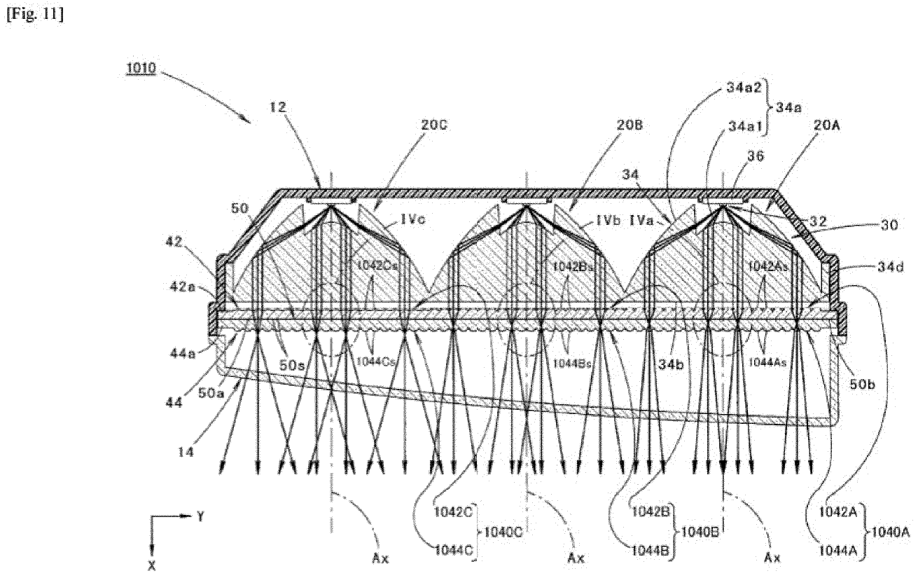

(a) of FIG. 13 is a detailed view of portion IVa shown in FIG. 11, (b) of FIG. 13 is a detailed view of portion IVb shown in FIG. 11, and (c) of FIG. 13 is a detailed view of portion IVc shown in FIG. 11.

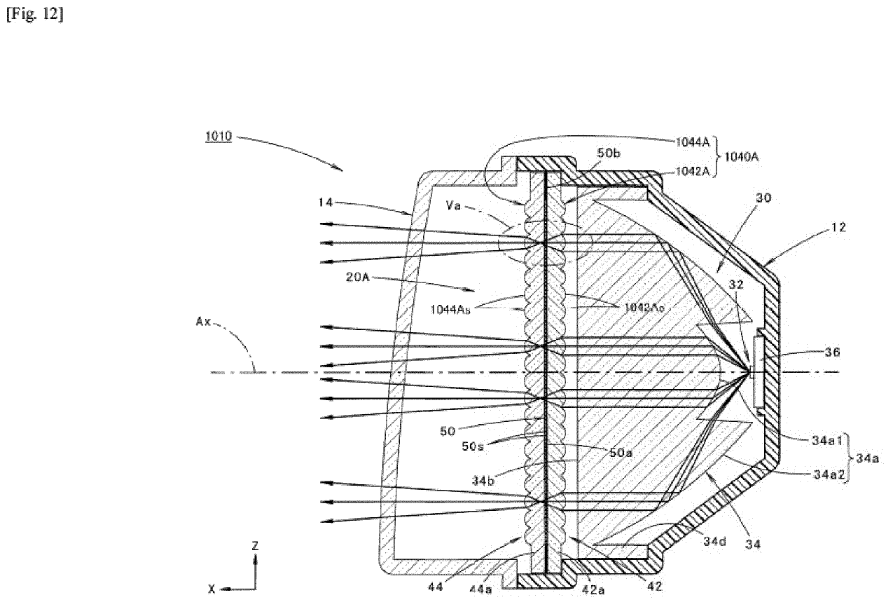

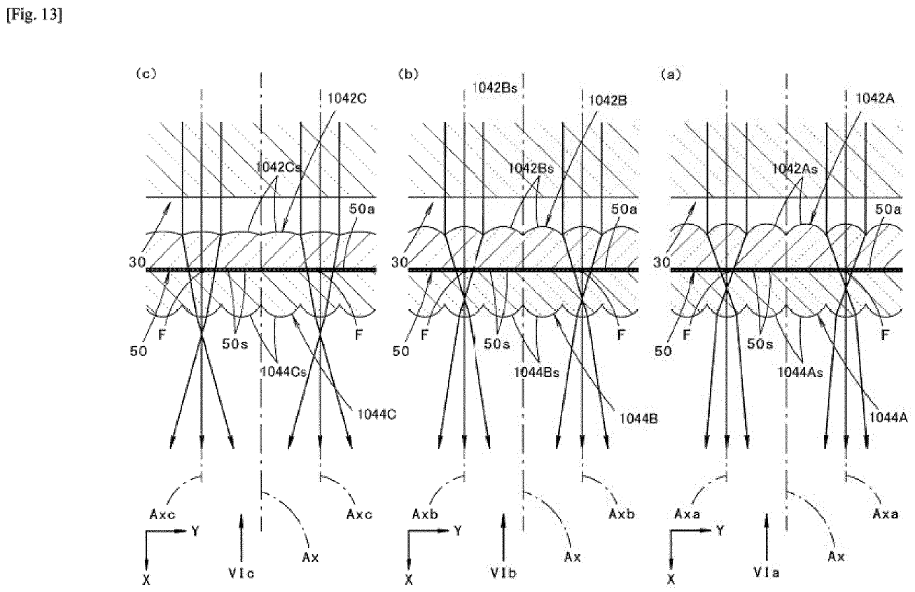

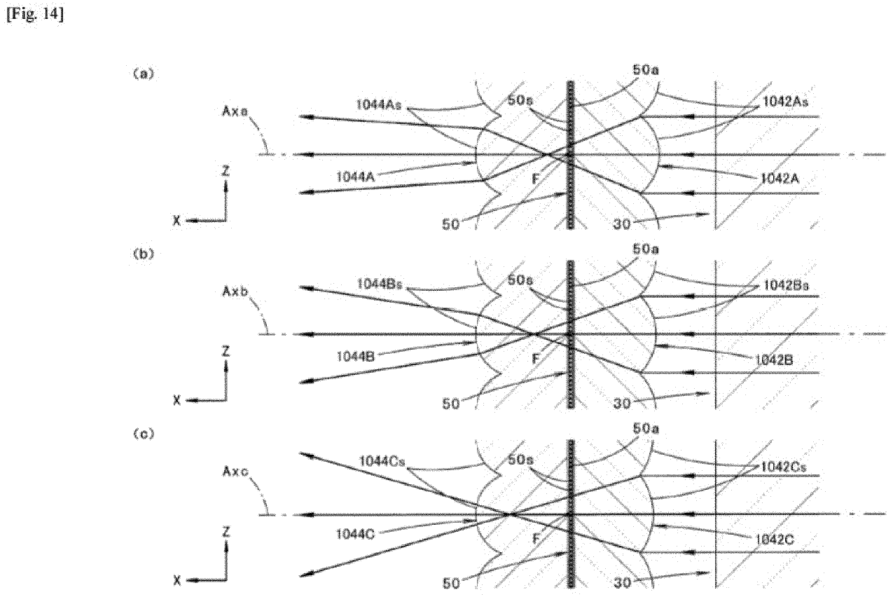

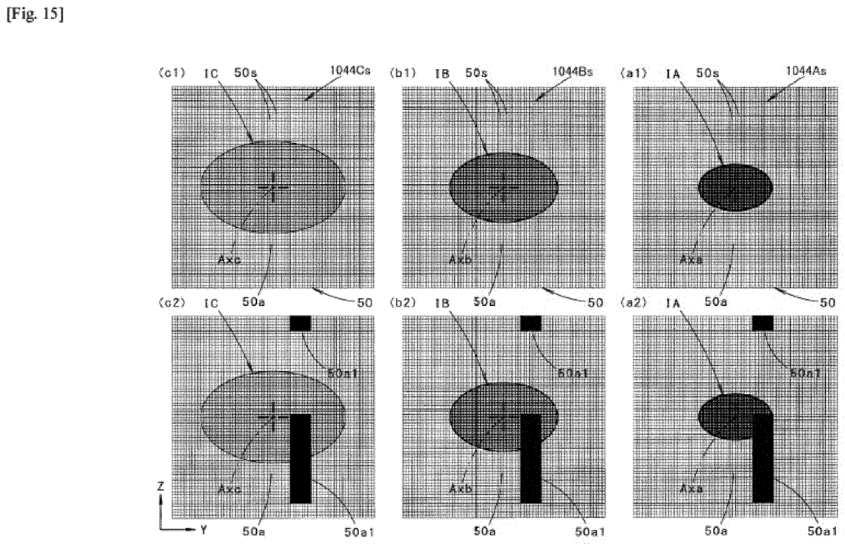

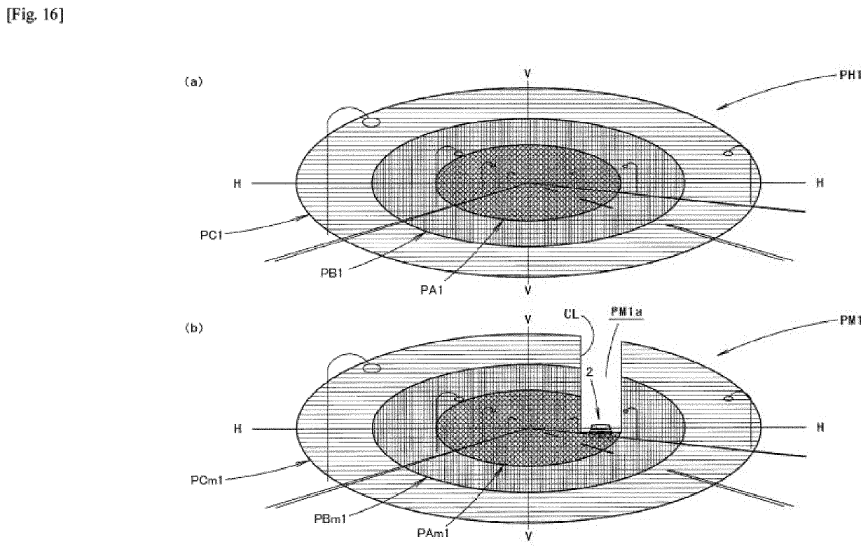

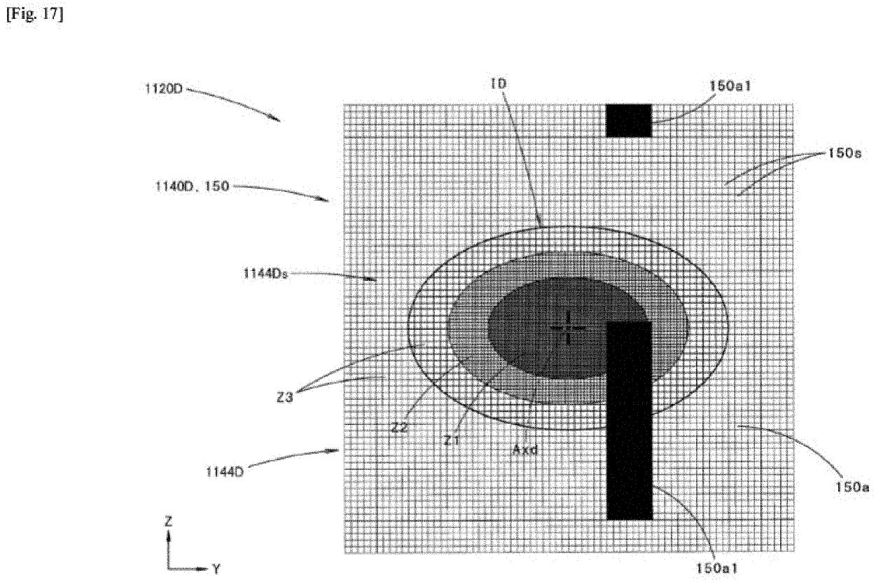

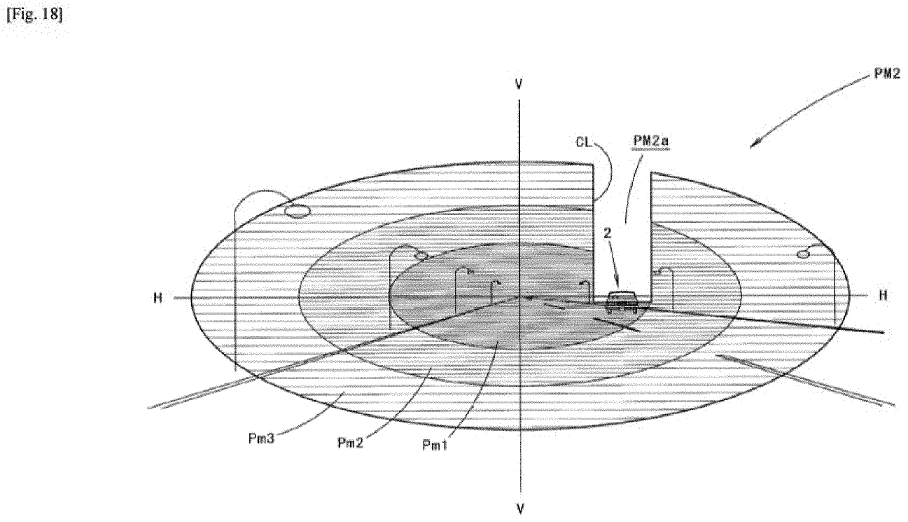

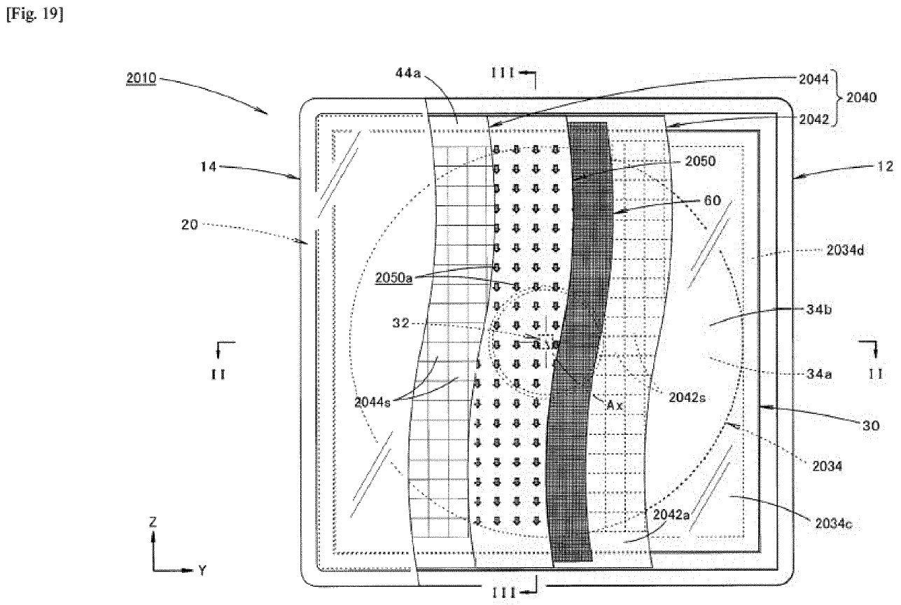

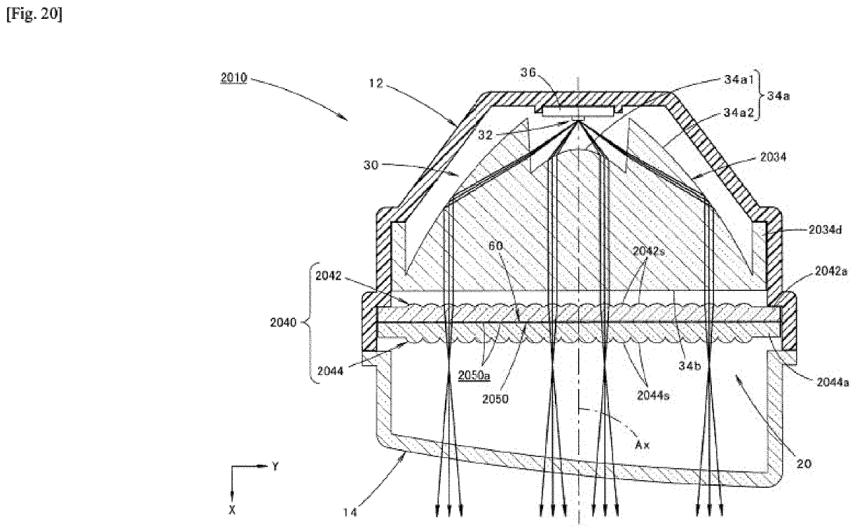

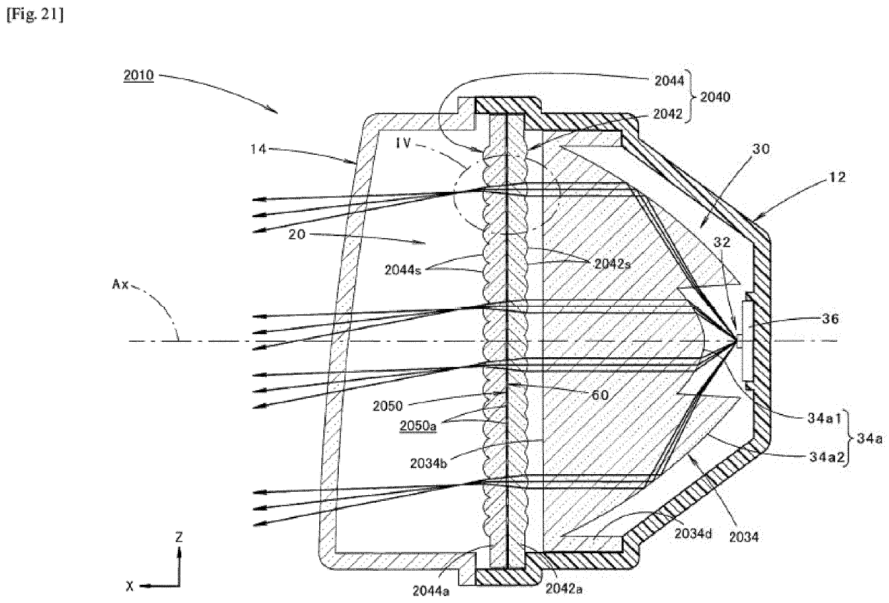

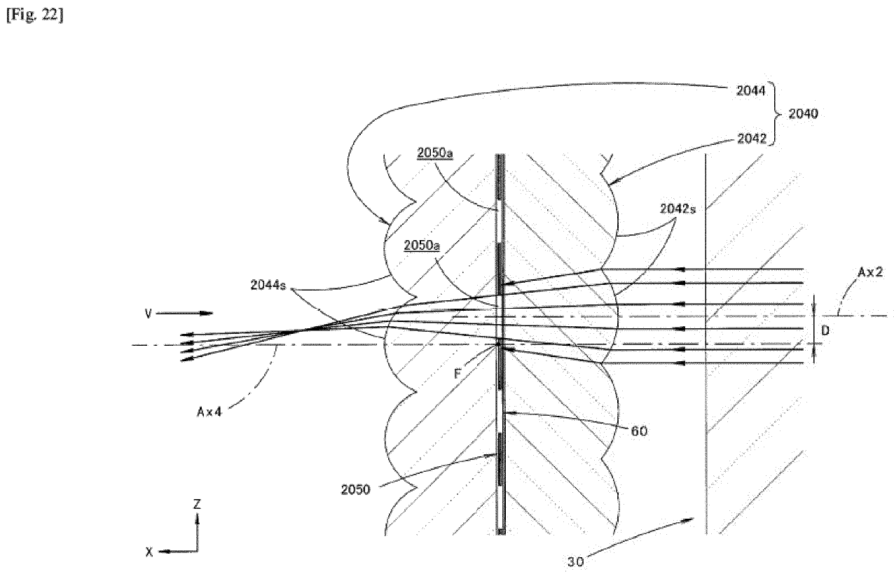

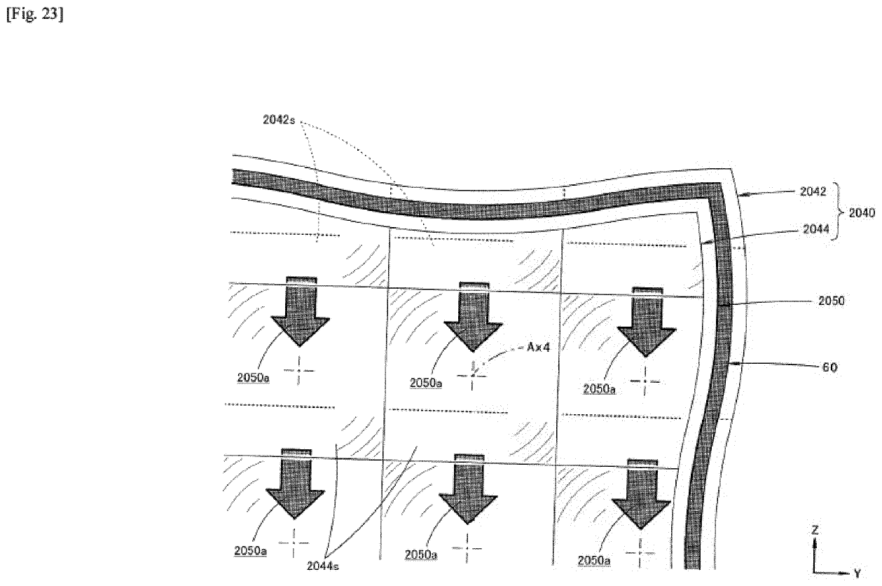

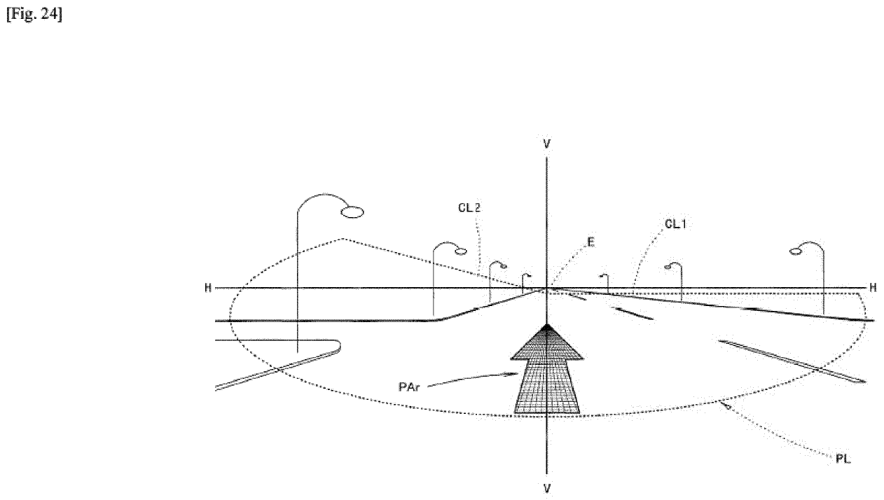

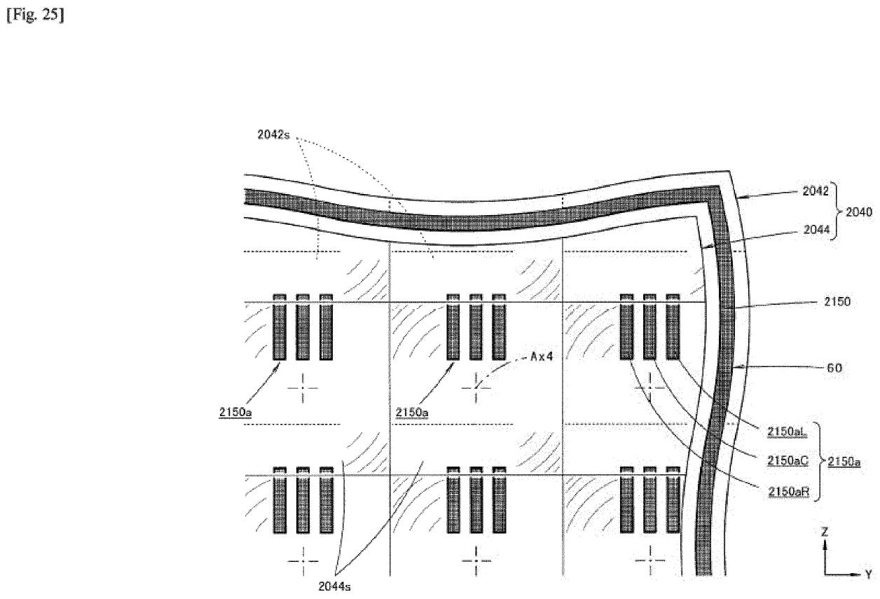

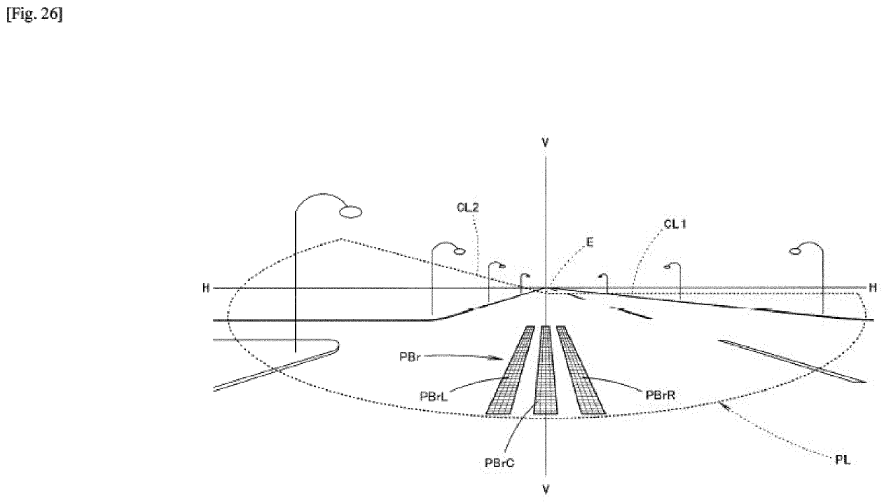

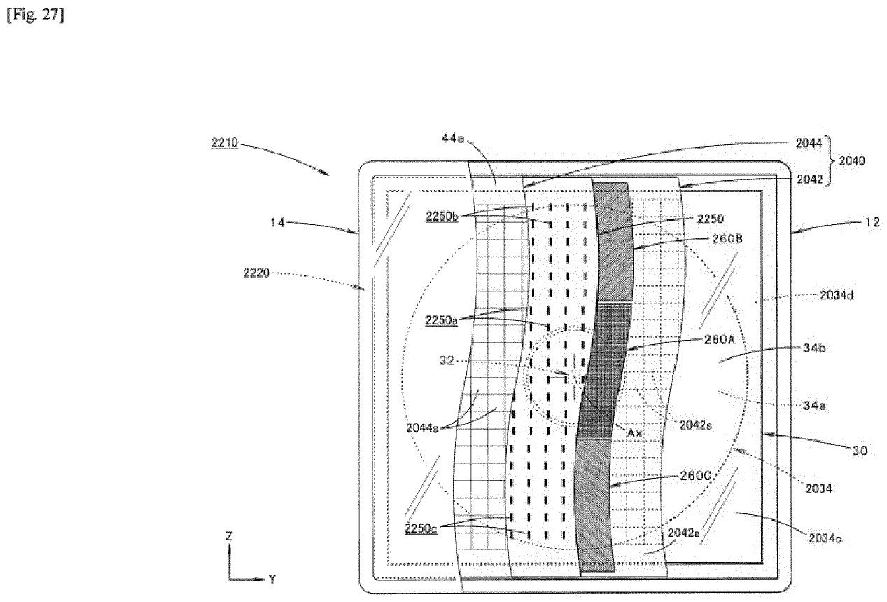

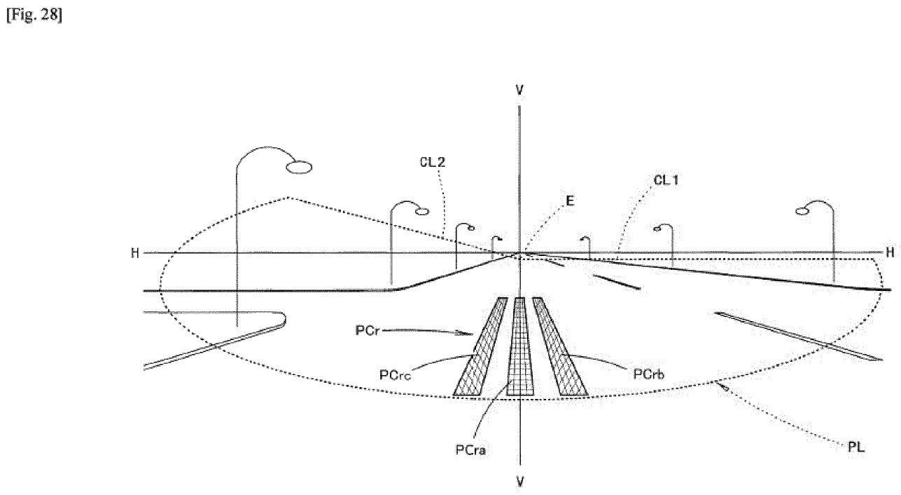

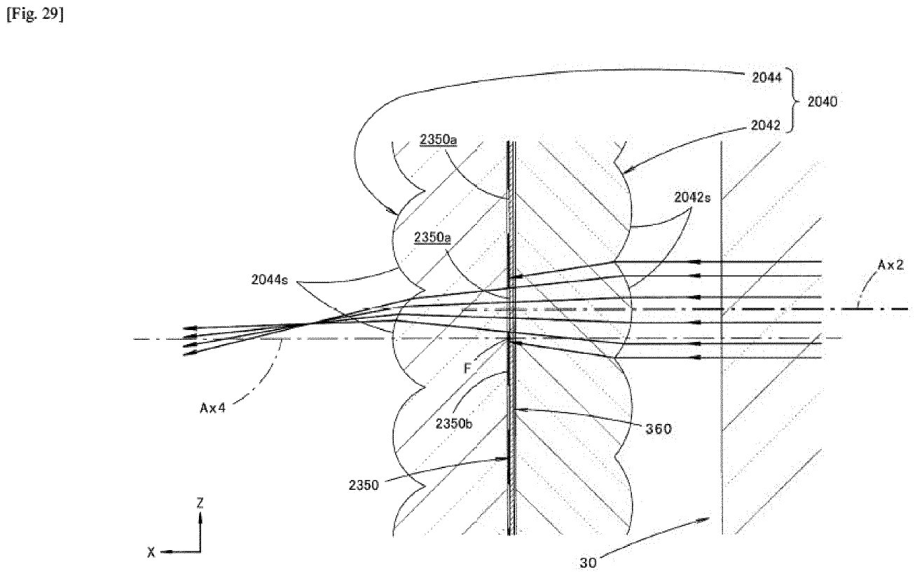

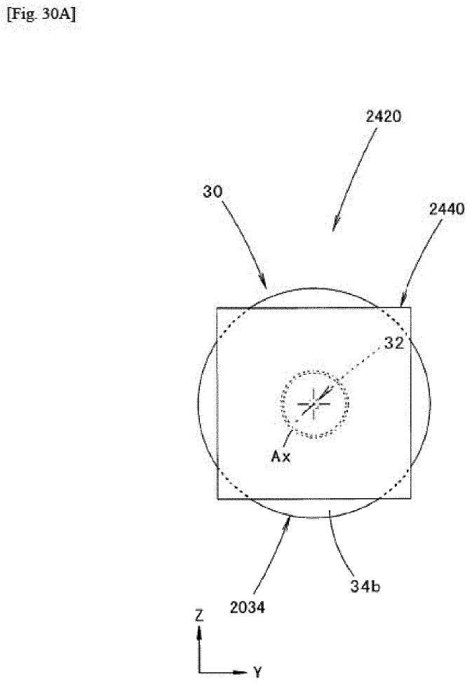

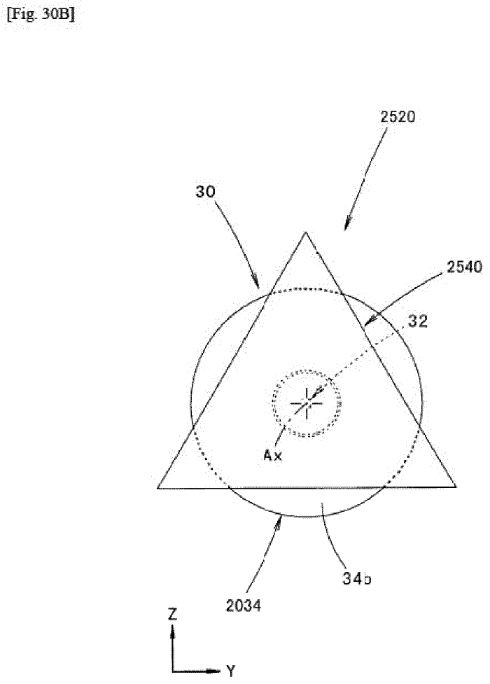

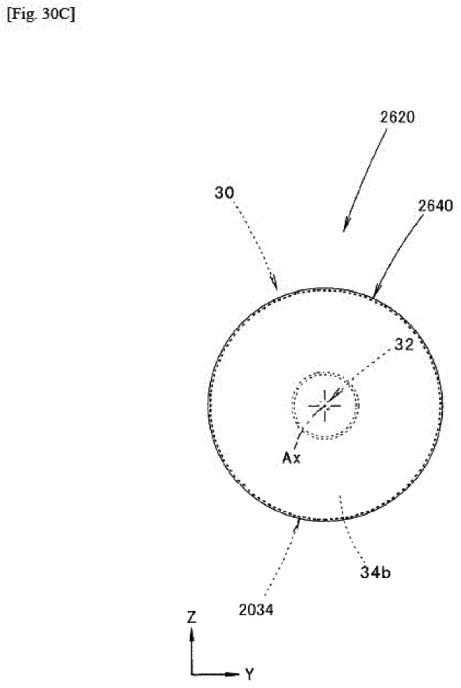

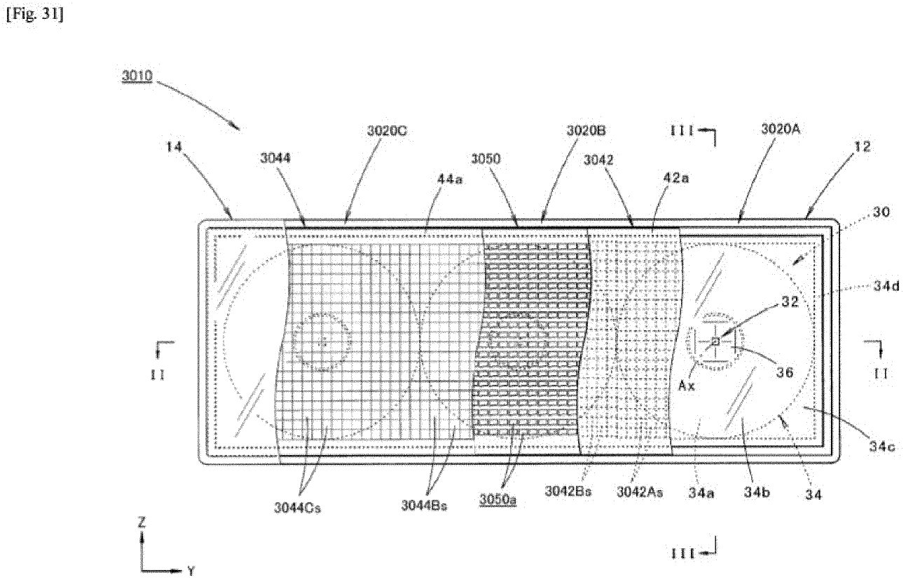

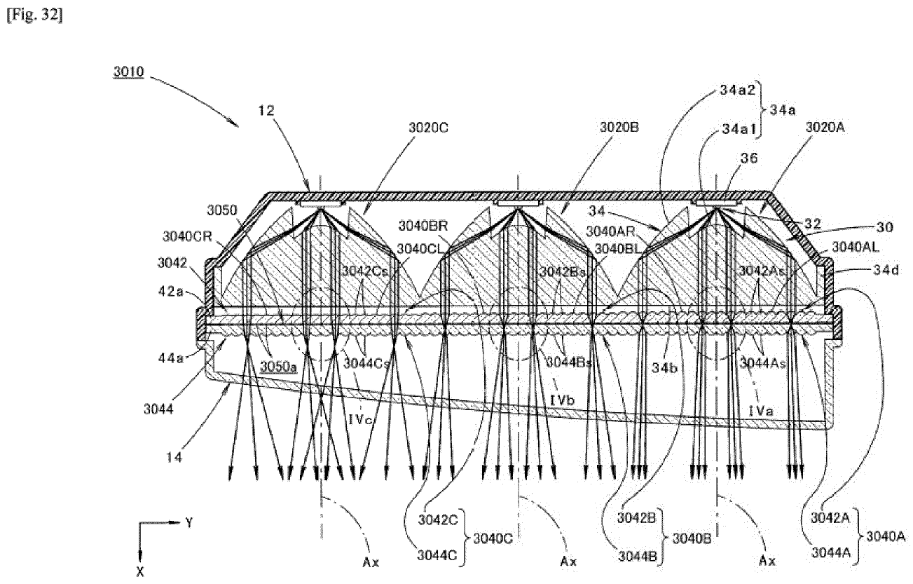

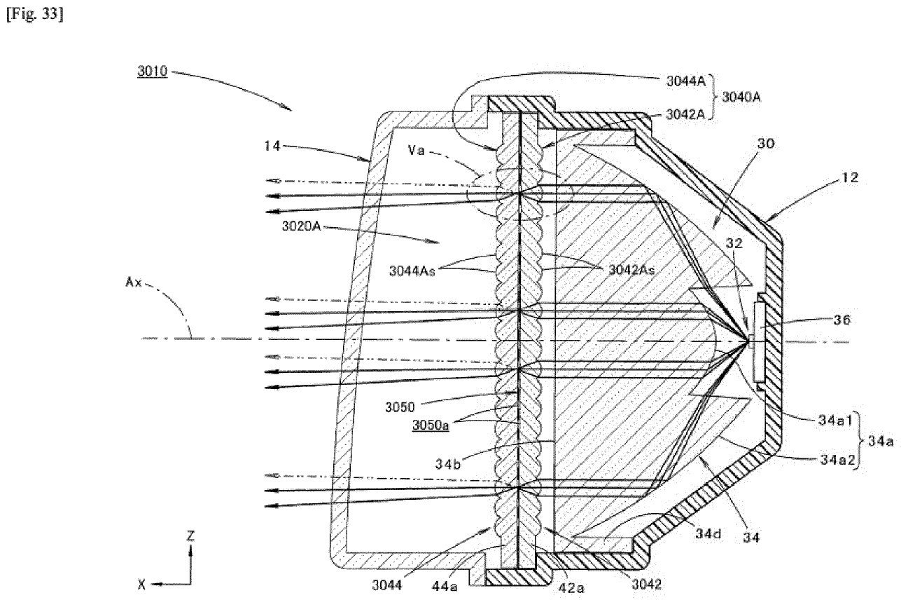

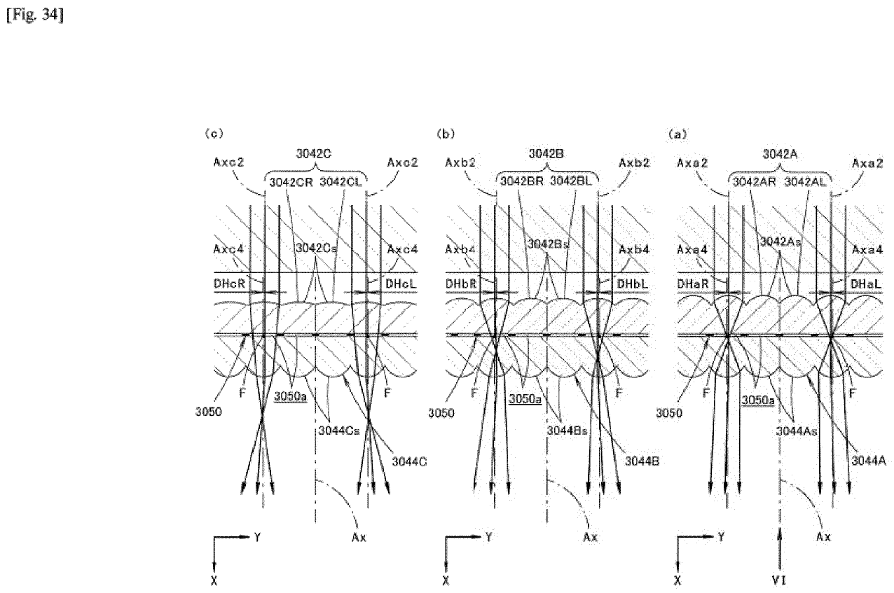

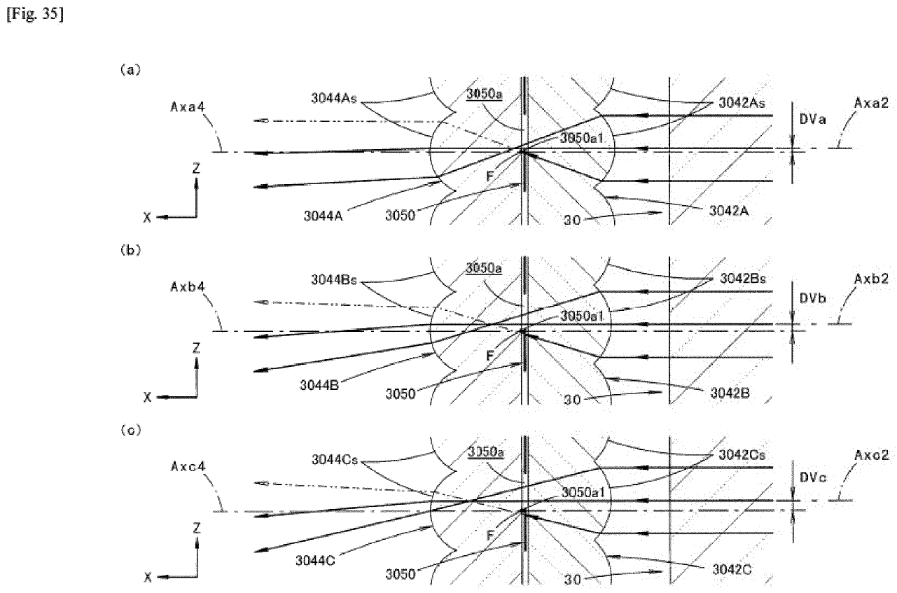

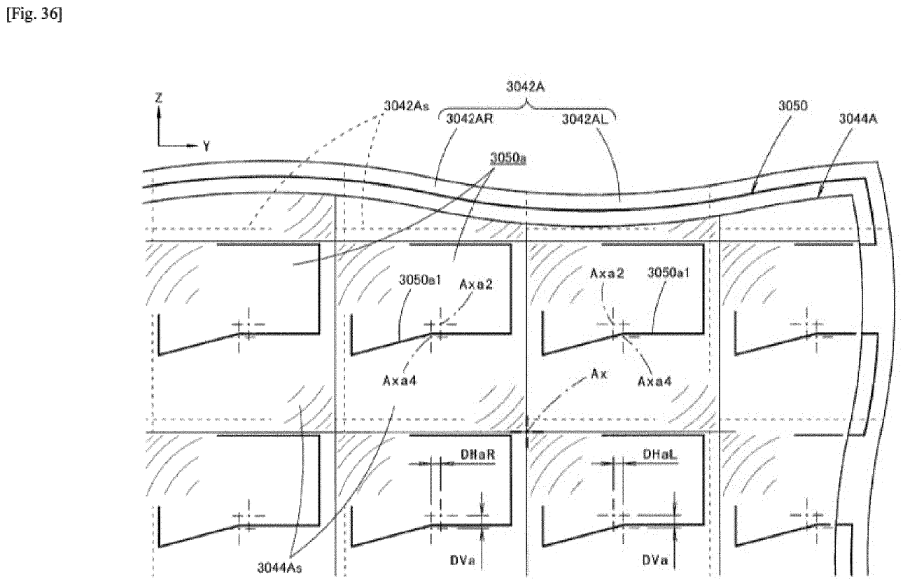

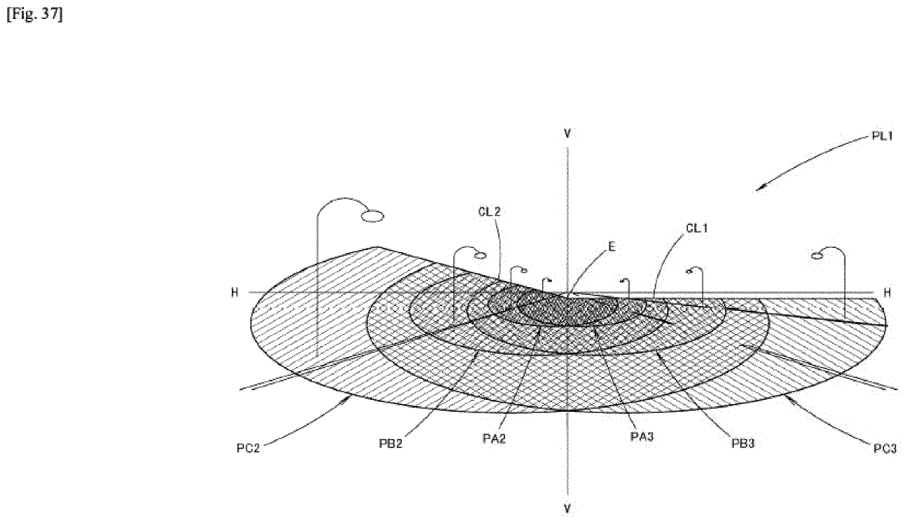

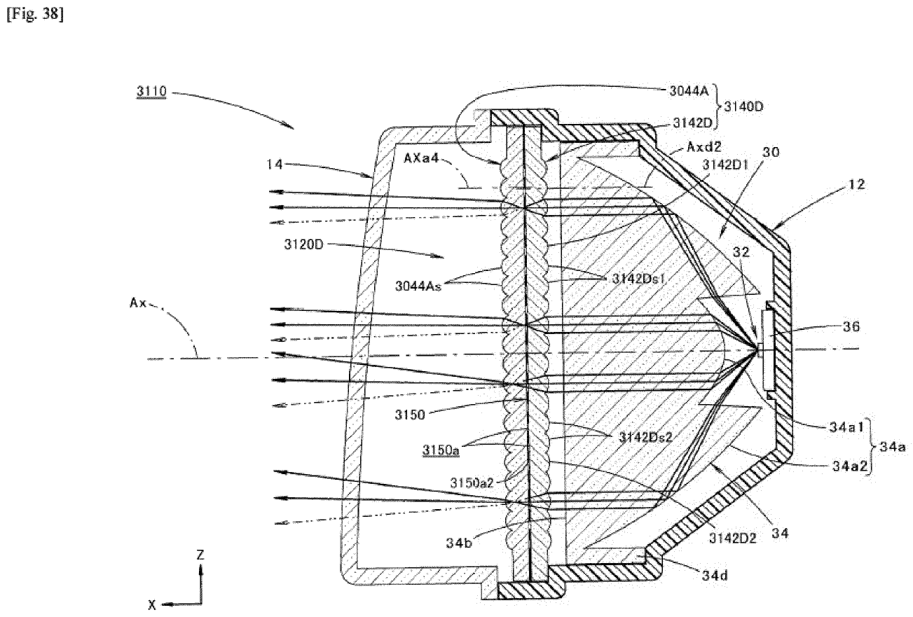

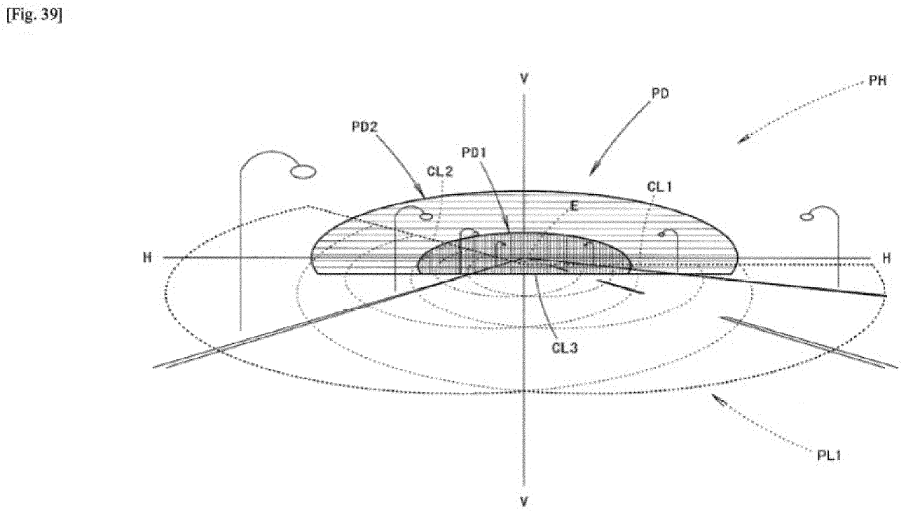

(a) of FIG. 14 is a detailed view of portion Va shown in FIG. 12, and (b) and (c) of FIG. 14 show other portions in the same manner as (a) of FIG. 14.

(a1) and (a2) of FIG. 15 are views taken in a direction of arrow VIa of FIGS. 13, (b1) and (b2) of FIG. 15 are views taken in a direction of arrow VIb of FIGS. 13, and (c1) and (c2) of FIG. 14 are views taken in a direction of arrow VIc of FIG. 13.

FIG. 16 transparently shows a light distribution pattern formed by light irradiated from the vehicle lamp.

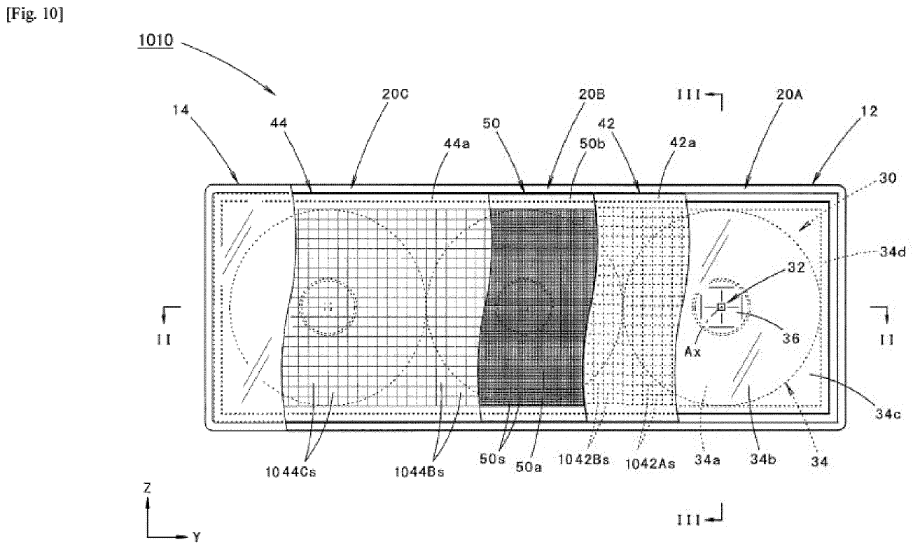

FIG. 17 shows a modification of the vehicle lamp shown in FIG. 10 in the same manner as FIG. 15.

FIG. 18 transparently shows a light distribution pattern formed by light irradiated from the vehicle lamp according to the modification shown in FIG. 17.

FIG. 19 is a front view showing a vehicle lamp according to an embodiment of the present disclosure.

FIG. 20 is a cross sectional view taken along line II-II of FIG. 19.

FIG. 21 is a cross sectional view taken along line III-III of FIG. 19.

FIG. 22 is a detailed view of portion IV shown in FIG. 21.

FIG. 23 is a view taken in a direction of arrow V of FIG. 22.

FIG. 24 transparently shows a light distribution pattern far road surface drawing formed by light irradiated from the vehicle lamp shown in FIG. 19.

FIG. 25 shows a first modification of the embodiment shown in FIG. 19 in the same manner as FIG. 23.

FIG. 26 shows an operation of the first modification shown in FIG. 25 in the same manner as FIG. 24.

FIG. 27 shows a second modification of the embodiment shown in FIG. 19 in the same manner as FIG. 19.

FIG. 28 shows an operation of the second modification shown in FIG. 27 in the same manner as FIG. 24.

FIG. 29 shows a third modification of the embodiment shown in FIG. 19 in the same manner as FIG. 22.

FIG. 30A shows a fourth modification of the embodiment shown in FIG. 19 in substantially the same manner as FIG. 19.

FIG. 30B shows a fifth modification of the embodiment shown in FIG. 19 in substantially the same manner as FIG. 19.

FIG. 30C shows a sixth modification of the embodiment shown in FIG. 19 in substantially the same manner as FIG. 19.

FIG. 31 is a front view showing a vehicle lamp according to an embodiment of the present disclosure.

FIG. 32 is a cross sectional view taken along line II-II of FIG. 31.

FIG. 33 is a cross sectional view taken along line III-III of FIG. 31.

(a) of FIG. 34 is a detailed view of portion IVa shown in FIG. 32, (b) of FIG. 34 is a detailed view of portion IVb shown in FIG. 32, and (c) of FIG. 34 is a detailed view of portion IVc shown in FIG. 32.

(a) of FIG. 35 is a detailed view of portion Va shown in FIG. 33, and (b) and (c) of FIG. 35 show other portions in the same manner as (a) of FIG. 35.

FIG. 36 is a view taken in a direction of arrow VI of FIG. 34.

FIG. 37 transparently shows a light distribution pattern fanned by light irradiated from the vehicle lamp shown in FIG. 31.

FIG. 38 shows a modification of the embodiment shown in FIG. 31 in the same manner as FIG. 33.

FIG. 39 transparently shows a light distribution pattern formed by light irradiated from the vehicle lamp according to the modification shown in FIG. 38.

### DESCRIPTION OF EMBODIMENTS

Hereinafter, embodiments of the present disclosure will be described with reference to the drawings.

### First Embodiment

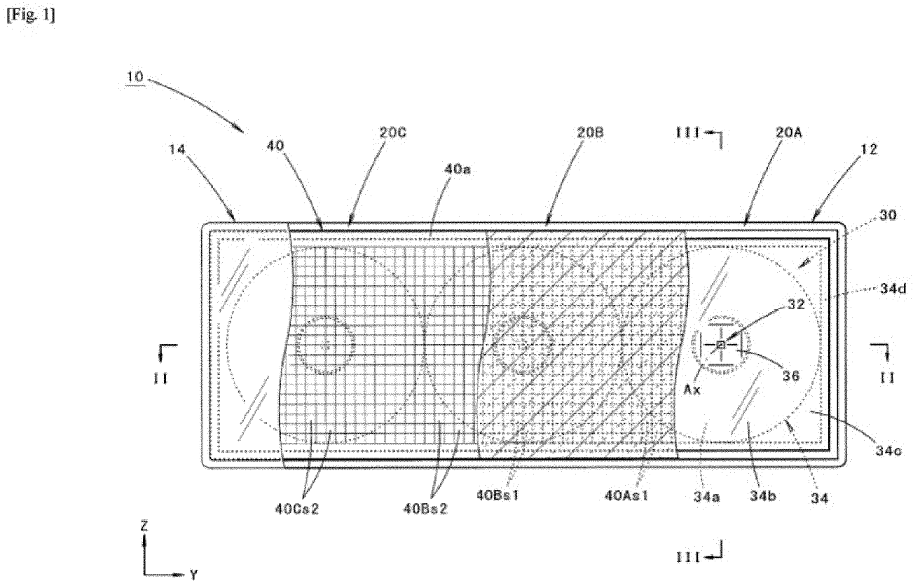

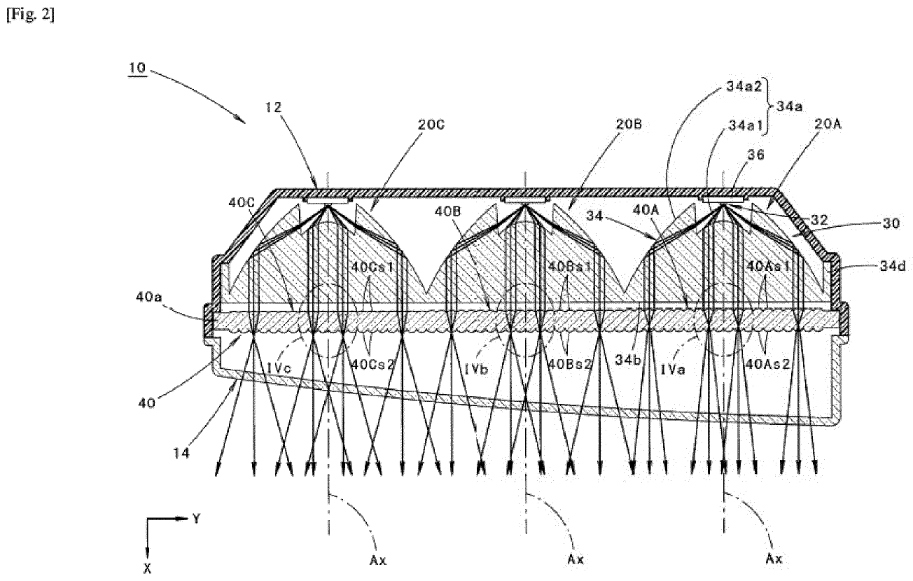

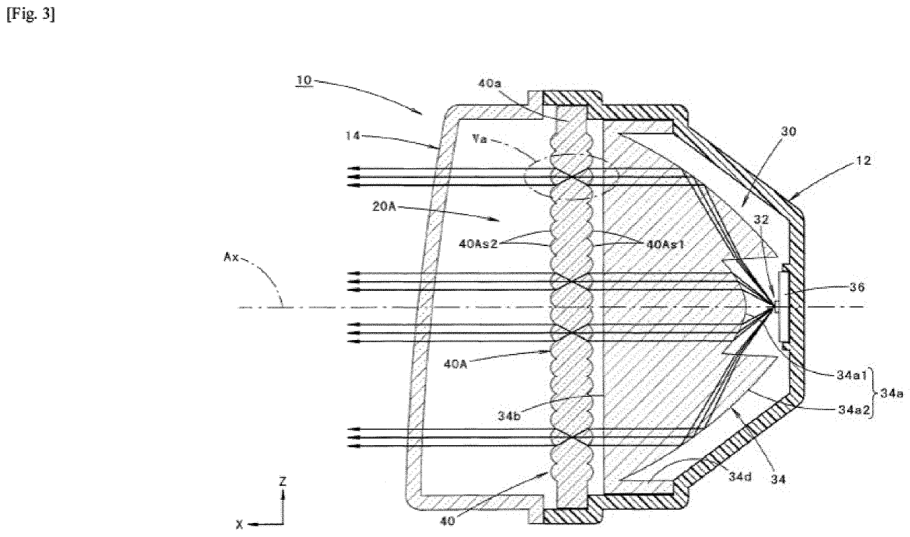

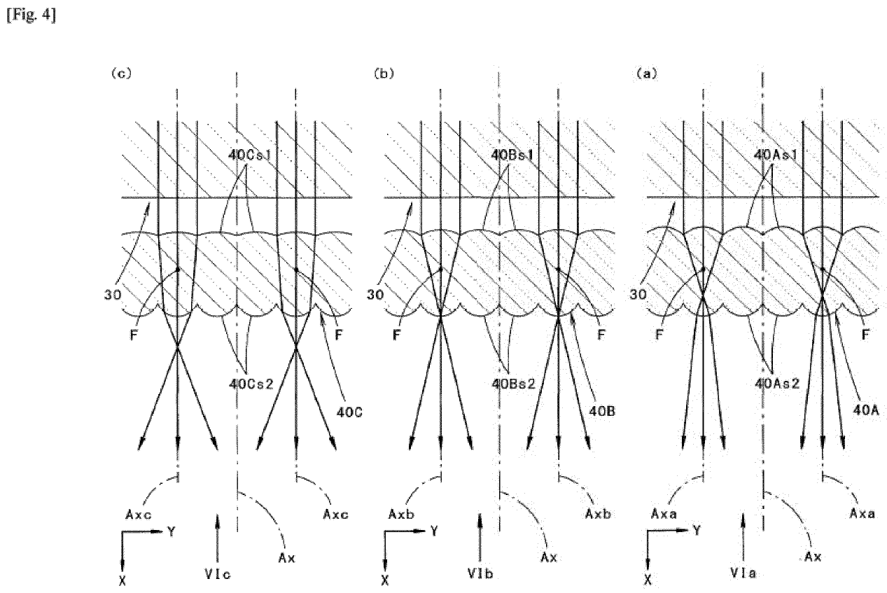

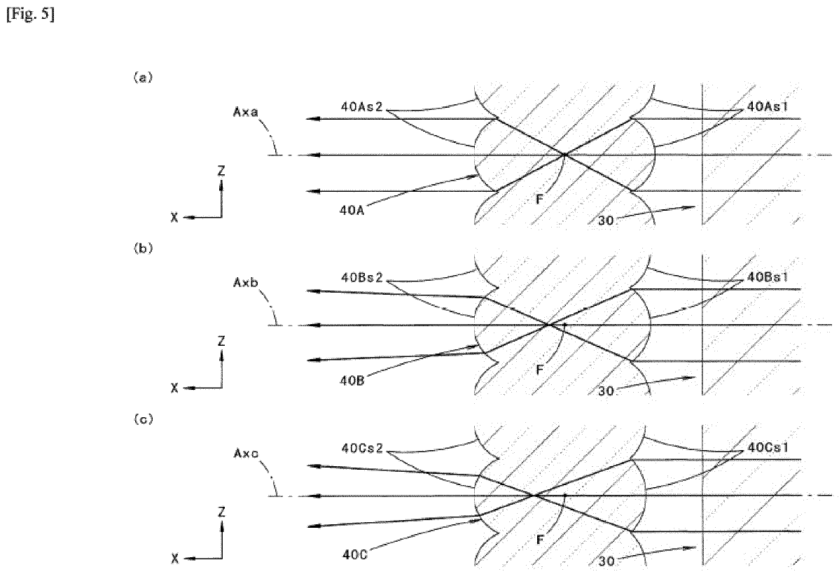

FIG. 1 is a front view showing a vehicle lamp 10 according to a first embodiment of the present disclosure. FIG. 2 is a cross sectional view taken along line II-II of FIG. 1, and FIG. 3 is a cross sectional view taken along line III-III of FIG. 1. In FIG. 1, a part of components are shown in a broken state.

In these drawings, a direction indicated by X is a “front side” of a lamp (also a “front side” of a vehicle), a direction indicated by Y is a “left direction” that is orthogonal to the “front side” (also a “left direction” of the vehicle, and a “right direction” in a lamp front view), and a direction indicated by Z is an “up direction”. The same also applies to the other drawings (including drawings of embodiments different from the present embodiment).

As shown in these drawings, the vehicle lamp 10 according to the present embodiment is a headlamp provided at a right front end portion of a vehicle, and has a configuration in which three lamp units 20A, 20B, and 20C are incorporated in a housing foamed by a lamp body 12 and a translucent cover 14 in a state of being aligned in a vehicle width direction.

The three lamp units 20A to 20C all have the same configuration and are configured to irradiate light emitted from a light source unit 30 toward a lamp front side via microlens arrays 40A, 40B, and 40C.

Each light source unit 30 includes a light source 32 and a translucent member 34 arranged on the lamp front side thereof.

Each light source 32 is a white light emitting diode, which has a rectangular (for example, square) light emitting surface, and is arranged to face the lamp front side in a state of being mounted on a board 36. Each board 36 is supported by the lamp body 12.

Each translucent member 34 includes an incident surface 34a on which the light from the light source 32 is incident, and an emission surface 34b from which the light incident from the incident surface 34a is emitted toward the lamp front side.

The incident surface 34a is formed of a rotating curved surface centered on an optical axis Ax which extends in a lamp front-rear direction so as to pass through a light emission center of the light source 32.

Specifically, the incident surface 34a includes a central region 34a1 that causes light from the light emission center of the light source 32 to be incident as light parallel to the optical axis Ax, and a peripheral region 34a2 around the central region 34a1, which causes the light from the light emission center of the light source 32 to be incident in a direction deviated from the optical axis Ax, and then internally reflects the light by total reflection as light parallel to the optical axis Ax.

Meanwhile, the emission surface 34b is configured by a flat surface extending along a vertical plane orthogonal to the optical axis Ax. The emission surface 34b emits the light from the light emission center of the light source 32 incident from the central region 32a1 of the incident surface 34a and the light from the light emission center of the light source 32 internally reflected by the peripheral region 34a2 toward the lamp front side as the light parallel to the optical axis Ax.

Three translucent members 34 are integrally formed as a transparent resin molded article.

Specifically, outer peripheral edge portions of the three translucent members 34 are connected to each other via a flat plate portion 34c which extends along the emission surface 34b. The resin molded article as a whole has a laterally long rectangular outer shape in the lamp front view. An outer peripheral flange portion 34d of the resin molded article is supported by the lamp body 12.

Each of the microlens arrays 40A to 40C has a configuration in which a plurality of condenser lens portions 40As1, 40Bs1, and 40Cs1 configured to converge the light emitted from each light source unit 30 are formed on a rear surface thereof while a plurality of projection lens portions 40As2, 40Bs2, and 40Cs2 configured to project a plurality of light source images formed by the plurality of condenser lens portions 40As1 to 40Cs1, respectively, are formed on a front surface thereof.

Each of the plurality of condenser lens portions 40As1 to 40Cs1 is a fish-eye lens which has a convex curved surface shape, and is allocated to each of a plurality of segments (for example, segments having a size of about 0.5 to 3 mm square) divided in a vertical and horizontal grid pattern.

Each of the plurality of projection lens portions 40As2 to 40Cs2 is a fish-eye lens which has a convex curved surface shape, and is allocated to each of a plurality of segments divided in a vertical and horizontal grid pattern with the same size as the condenser lens portions 40As1 to 40Cs1.

Side end portions of the three microlens arrays 40A to 40C are connected to each other. The three microlens arrays 40A to 40C are configured as a translucent plate 40 which has a laterally long rectangular outer shape as a whole. On the translucent plate 40, a laterally long rectangular outer peripheral edge region 40a, which surrounds portions where the plurality of condenser lens portions 40As1 to 40Cs1 and the plurality of projection lens portions 40As2 to 40Cs2 are formed on the three microlens arrays 40A to 40C, is formed in a flat plate shape. The outer peripheral edge region 40a of the translucent plate 40 is supported by the lamp body 12.

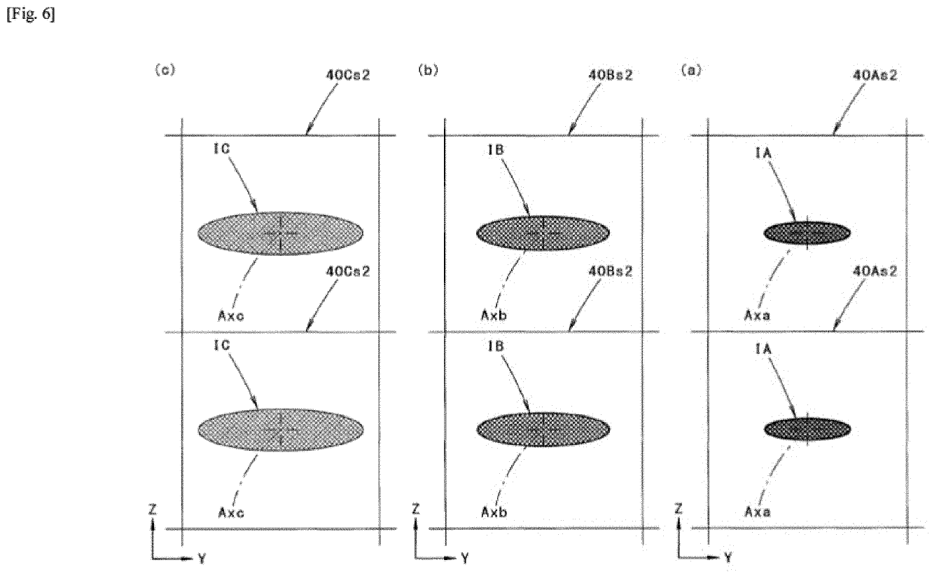

(a) of FIG. 4 is a detailed view of portion IVa shown in FIG. 2, (b) of FIG. 4 is a detailed view of portion IVb shown in FIG. 2, and (c) of FIG. 4 is a detailed view of portion IVc shown in FIG. 2. (a) of FIG. 5 is a detailed view of portion Va shown in FIG. 3, which shows a main part of the lamp unit 20A. (b) and (c) of FIG. 5 show main parts of the lamp units 20B and 20C, respectively, in the same manner as (a) of FIG. 5. Further, (a) of FIG. 6 is a view taken in a direction of arrow VIa of (a) of FIG. 4, (b) of FIG. 6 is a view taken in a direction of arrow VIb of (b) of FIG. 4, and (c) of FIG. 6 is a view taken in a direction of arrow VIc of (c) of FIG. 4.

As shown in these drawings, the plurality of projection lens portions 40As2 to 40Cs2 formed on the front surfaces of the three microlens arrays 40A to 40C have spherical surface shapes having the same curvature. The projection lens portions 40As2 to 40Cs2 have optical axes Axa, Axb, and Axe which extend in the lamp front-rear direction, while rear focus points F thereof are located in the vicinity of lamp front-rear direction centers of the microlens arrays 40A to 40C.

The plurality of condenser lens portions 40As1 to 40Cs1 formed on the rear surfaces of the three microlens arrays 40A to 40C are also arranged on the optical axes Axa to Axe of the corresponding projection lens portions 40As2 to 40Cs2 (that is, located in the lamp front direction of the condenser lens portions 40As1 to 40Cs1, respectively).

As shown in (a) of FIG. 5, the condenser lens portion 40As1 of the microlens array 40A has an arc-shaped vertical cross-sectional shape whose surface has a curvature equal to that of the spherical surface constituting the surface of the projection lens portion 40As2, and a front focus point in a vertical plane thereof is located in the vicinity of the rear focus point F of the projection lens portion 40As2.

As shown in (a) of FIG. 4, the condenser lens portion 40As1 has an arc-shaped horizontal cross-sectional shape whose surface has a curvature smaller than that of the spherical surface constituting the surface of the projection lens portion 40As2, and a front focus point in a horizontal plane thereof is located on the lamp front side relative to the front focus point in the vertical plane.

As a result, as shown in (a) of FIG. 6, the condenser lens portion 40As1 forms a small and laterally long light source image IA on a rear focal plane of the projection lens portion 40As2.

As shown in (b) of FIG. 5, the condenser lens portion 40Bs1 of the microlens array 40B has an arc-shaped vertical cross-sectional shape whose surface has a curvature smaller than that of the spherical surface constituting the surface of the projection lens portion 40Bs2, and a front focus point in a vertical plane thereof is located on the lamp front side relative to the rear focus point F of the projection lens portion 40Bs2.

As shown in (b) of FIG. 4, the condenser lens portion 40Bs1 has an arc-shaped horizontal cross-sectional shape whose surface has a curvature smaller than that of the spherical surface constituting the surface of the projection lens portion 40Bs2, and a front focus point in a horizontal plane thereof is located on the lamp front side relative to the front focus point in the vertical plane.

As a result, as shown in (b) of FIG. 6, the condenser lens portion 40Bs1 forms a laterally long light source image IB which has a medium size on a rear focal plane of the projection lens portion 40Bs2.

As shown in (c) of FIG. 5, the condenser lens portion 40Cs1 of the microlens array 40C has an arc-shaped vertical cross-sectional shape whose surface has a curvature smaller than that of the spherical surface constituting the surface of the projection lens portion 40Cs2, and a front focus point in a vertical plane thereof is located on the lamp front side relative to the rear focus point F of the projection lens portion 40Cs2. A forward displacement amount in this case is larger than that in the case of the condenser lens portion 40Bs1 of the microlens array 40B.

As shown in (c) of FIG. 4, the condenser lens portion 40Cs1 has an arc-shaped horizontal cross-sectional shape whose surface has a curvature smaller than that of the spherical surface constituting the surface of the projection lens portion 40Cs2, and a front focus point in a horizontal plane thereof is located on the lamp front side relative to the front focus point in the vertical plane.

As a result, as shown in (c) of FIG. 6, the condenser lens portion 40Cs1 forms a considerably large and laterally long light source image IC on a rear focal plane of the projection lens portion 40Cs2.

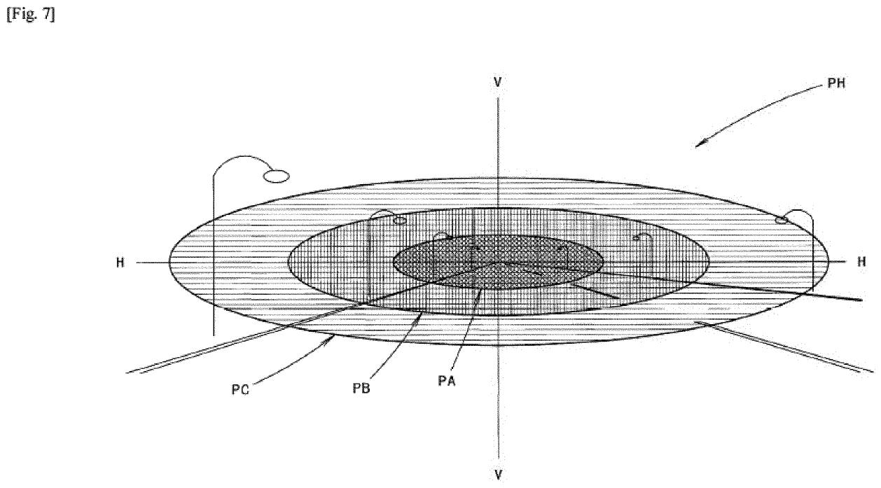

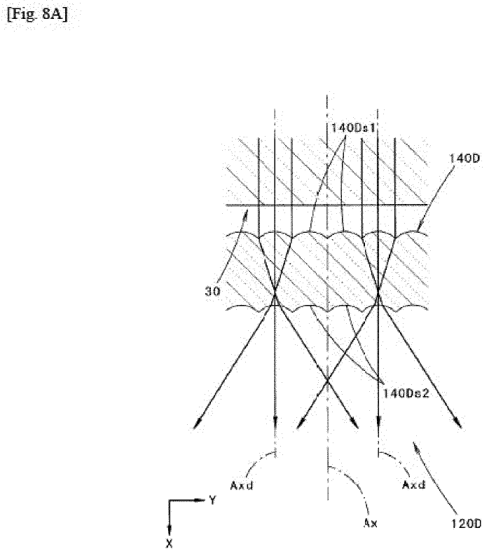

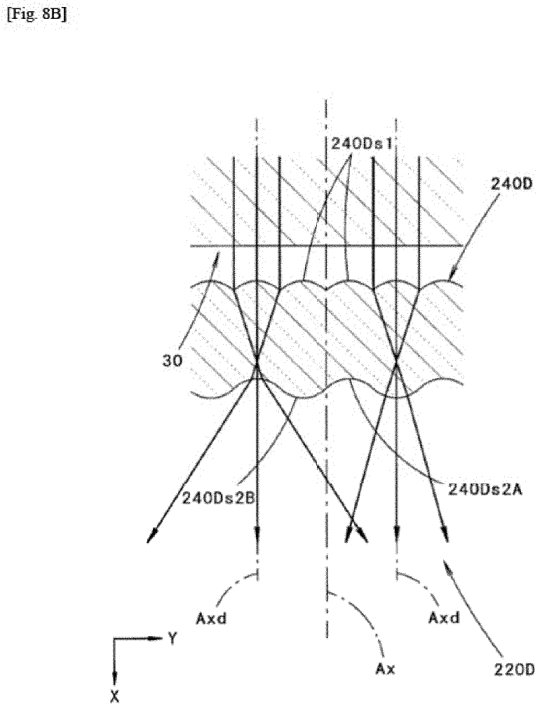

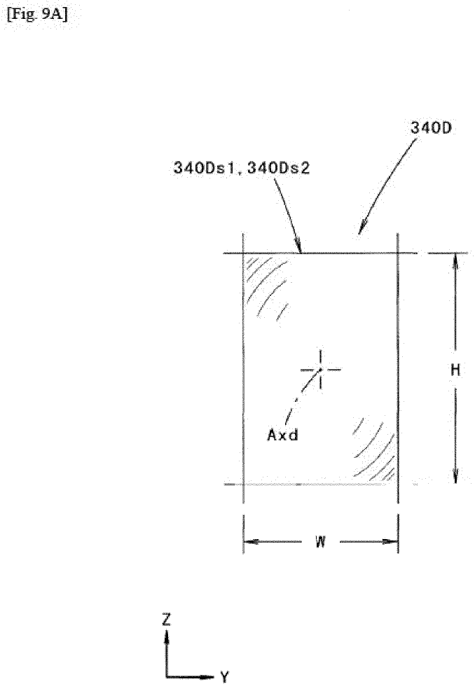

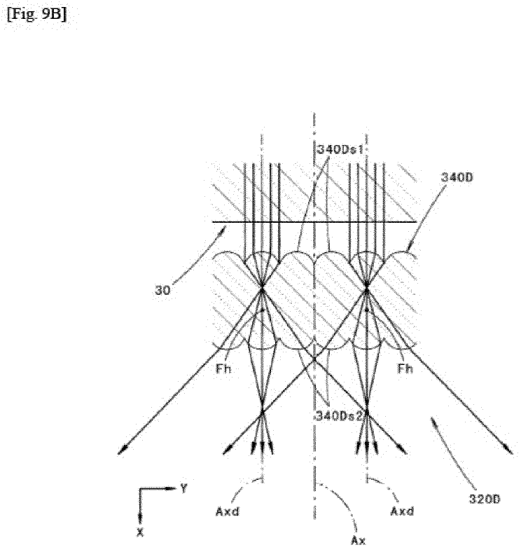

FIG. 7 transparently shows a high-beam light distribution pattern PH formed by the light irradiated from the vehicle lamp 10 on a virtual vertical screen arranged at a position 25 m ahead of the vehicle.

The high-beam light distribution pattern PH is a laterally long light distribution pattern which is centered on line V-V passing through H-V (a vanishing point in the lamp front direction) in the vertical direction and is widely spread in a horizontal direction. The high-beam light distribution pattern PH is formed as a combined light distribution pattern of three light distribution patterns PA, PB, and PC.

The light distribution pattern PA is a light distribution pattern formed by light irradiated from the lamp unit 20A as an inverted projection image of the light source image IA, and is formed as a small, bright and laterally long light distribution pattern centered on H-V. As a result, a high luminous intensity region of the high-beam light distribution pattern PH is formed.

The light distribution pattern PB is a light distribution pattern which is formed by light irradiated from the lamp unit 20B as an inverted projection image of the light source image IB, and is formed concentrically with the light distribution pattern PA as a laterally long light distribution pattern which is slightly larger than the light distribution pattern PA. As a result, an intermediate diffusion region of the high-beam light distribution pattern PH is formed.

The light distribution pattern PC is a light distribution pattern formed by light irradiated from the lamp unit 20C as an inverted projection image of the light source image IC, and is formed concentrically with the light distribution pattern PA as a laterally long light distribution pattern which is further slightly larger than the light distribution pattern PB. As a result, a high diffusion region of the high-beam light distribution pattern PH is formed.

As described above, since the high-beam light distribution pattern PH is formed as the combined light distribution pattern of the three types of light distribution patterns PA, PB, and PC which have different sizes and brightness, the high-beam light distribution pattern PH is a light distribution pattern having excellent distant visibility and less light distribution unevenness.

Next, an operation of the present embodiment will be described.

The vehicle lamp 10 according to the present embodiment includes the three lamp units 20A, 20B, and 20C. Each of the lamp units 20A to 20C is configured to form the high-beam light distribution pattern PH (a required light distribution pattern) by irradiating the light emitted from the light source unit 30 toward the lamp front side via the microlens arrays 40A, 40B, and 40C. Since the microlens arrays 40A to 40C are configured to form the laterally long light distribution patterns PA, PB and PC by the emitted light thereof, the laterally long high-beam light distribution pattern PH can be formed as the combined light distribution pattern of the light distribution patterns PA, PB and PC without using any light shielding plate. Therefore, light shielded by the light shielding plate is not wasted, and thus a light source light flux can be effectively used.

As described above, according to the present embodiment, the vehicle lamp 10 including the microlens arrays 40A to 40C can form the laterally long light distribution pattern while effectively using the light source light flux.

Moreover, according to the present embodiment a configuration of the lamp can be simplified since no light shielding plate is used.

According to the present embodiment, since the curvature of the surface of each of the condenser lens portions 40As1, 40Bs1, and 40Cs1 formed on the rear surfaces of the microlens arrays 40A to 40C is set to have a larger value in the vertical plane than in the horizontal plane, a left-right direction diffusion angle of the light emitted from the microlens arrays 40A to 40C can easily become larger than an up-down direction diffusion angle.

The curvature in the horizontal plane of the surface of each of the condenser lens portions 40As1 to 40Cs1 of the microlens arrays 40A to 40C is set to a value smaller than the curvature in the horizontal plane of the surface of each of the projection lens portions 40As2, 40Bs2, and 40Cs2 corresponding to the condenser lens portions 40As1 to 40Cs1. In this respect as well, the left-right direction diffusion angle of the light emitted from the microlens arrays 40A to 40C can easily become larger than the up-down direction diffusion angle.

Although the curvature of the surface of each of the condenser lens portions 40As1 to 40Cs1 is set to have a larger value in the vertical plane than in the horizontal plane over an entire region of each of the microlens arrays 40A to 40C in the above-described embodiment, a configuration in which only a part of the region is set in this way may also be adopted.

Although the curvature in the horizontal plane of the surface of each of the condenser lens portions 40As1 to 40Cs1 is set to a smaller value than the curvature in the horizontal plane of the surface of each of the projection lens portions 40As2 to 40Cs2 corresponding to each of the condenser lens portions 40As1 to 40Cs1 over the entire region of each of the microlens arrays 40A to 40C in the above-described embodiment, a configuration in which only a part of the region is set in this way may also be adopted.

Although the high-beam light distribution pattern PH is formed by the light irradiated from the vehicle lamp 10 in the above embodiment, other light distribution patterns (for example, a laterally long light distribution pattern constituting a diffusion region of a low-beam light distribution pattern) may also be formed.

Although the condenser lens portions 40As1 to 40Cs1 and the projection lens portions 40As2 to 40Cs2 of the microlens arrays 40A to 40C are allocated to each of the plurality of segments divided in the vertical and horizontal grid pattern in the above-described embodiment, it is also possible to adopt a division other than the vertical and horizontal grid pattern (for example, a division of an diagonal grid pattern).

Although each light source 32 is configured by the white light emitting diode in the above-described embodiment. other light sources (for example. a laser diode or an organic EL) may also be used.

### First Modification of First Embodiment

Next, modifications of the first embodiment will be described.

First, a first modification of the first embodiment will be described.

FIG. 8A shows a main part of a vehicle lamp according to the present modification in the same manner as (a) of FIG. 4.

As shown in FIG. 8A, a basic configuration of the present modification is similar to that of the above-described embodiment, while a lamp unit 120D is provided instead of the lamp unit 20A of the above-described embodiment, which is partially different from the first embodiment.

That is, a configuration of a microlens array 140D of the lamp unit 120D of the present modification is partially different from that of the microlens array 40A of the first embodiment.

Specifically, a horizontal cross section of a projection lens portion 140Ds2 formed on a front surface of the microlens array 140D of the present modification is formed in a concave curved shape, which is different from the first embodiment.

A condenser lens portion 140Ds1 formed on a rear surface of the microlens array 140D of the present modification is arranged on an optical axis Axd of the corresponding projection lens portion 140Ds2, and a configuration thereof is the same as the condenser lens portion 40As1 of the first embodiment A vertical cross-sectional shape of the projection lens portion 140Ds2 is also the same as that of the projection lens portion 40As2 of the first embodiment.

A curvature of the concave curve constituting the horizontal cross-sectional shape of the projection lens portion 140Ds2 is set to be substantially the same value as a curvature of a convex curve constituting a horizontal cross-sectional shape of the condenser lens portion 140Ds1.

Since the horizontal cross section of the projection lens portion 140Ds2 of the microlens array 140D of the present modification is formed in the concave curved shape, the light from the light source unit 30 incident from a condenser lens portion 140As1 is emitted from the projection lens portion 140Ds2 toward the lamp front side with a large left-right direction diffusion angle.

By adopting the configuration of the present modification, an elongated light distribution pattern, in which the light distribution pattern PA formed by the light irradiated from the lamp unit 20A of the first embodiment is widely expanded in the left-right direction while an up-down width of the light distribution pattern PA is maintained, can be formed.

By adopting the configuration of the present modification, a left-right direction diffusion angle of light emitted from the microlens array 140D can easily become significantly larger than an up-down direction diffusion angle.

It should be noted that a configuration in which a partial region of the microlens array 40A of the first embodiment is replaced with the configuration of the microlens array 140D of the present modification may also be adopted.

### Second Modification of First Embodiment

Next, a second modification of the first embodiment will be described.

FIG. 8B shows a main part of a vehicle lamp according to the present modification in the same manner as (a) of FIG. 4.

As shown in FIG. 8B, a basic configuration of a lamp unit 220D of the present modification is similar to that of the first modification, while a horizontal cross-sectional shape of a front surface of a microlens array 240D of the present modification is formed in a corrugated curved shape, which is different from the first modification.

That is, the front surface of the microlens array 240D of the present modification has a horizontal cross-sectional shape in which a projection lens portion 240Ds2A having a concave curved horizontal cross-sectional shape similar to that of the projection lens portion 140Ds2 of the first modification and a projection lens portion 240Ds2B having a convex curved horizontal cross-sectional shape obtained by reversing the projection lens portion 240Ds2A in the front-rear direction are smoothly connected with each other.

The horizontal cross section of each of the projection lens portions 240Ds2A and 240Ds2B of the microlens array 24013 of the present modification is formed in the corrugated curved shape. Therefore, the light from the light source unit 30 incident from a condenser lens portion 240Ds1 is emitted from the projection lens portion 240Ds2A, which has the concave curved horizontal cross-sectional shape, to the lamp front side with a large left-right direction diffusion angle, and is emitted from the projection lens portion 240Ds2B, which has the convex curved horizontal cross-sectional shape, to the lamp front side with a relatively small left-right direction diffusion angle.

By adopting the configuration of the present modification, an elongated light distribution pattern, in which the light distribution pattern PA formed by the light irradiated from the lamp unit 20A of the first embodiment is widely expanded in the left-right direction while the up-down width of the light distribution pattern PA is maintained, can be formed while brightness of a central region thereof is sufficiently ensured.

By adopting the configuration of the present modification, a left-right direction diffusion angle of light emitted from the microlens array 240D can easily become significantly larger than an up-down direction diffusion angle, and it is also possible to increase central luminous intensity thereof.

### Third Modification of First Embodiment

Next, a third modification of the first embodiment will be described.

FIG. 9A shows a main part of a vehicle lamp according to the present modification in the same manner as (a) of FIG. 6, and FIG. 9B shows the main part in the same manner as (a) of FIG. 4.

As shown in these drawings, a basic configuration of the present modification is similar to that of the first embodiment, while a lamp unit 320D is provided instead of the lamp unit 20A of the first embodiment, which is partially different from the first embodiment.

That is, a configuration of a microlens array 340D of the lamp unit 320D of the present modification is partially different from that of the microlens array 40A of the first embodiment.

Specifically, a height H of each of a condenser lens portion 340Ds1 and a projection lens portion 340Ds2 of the microlens way 340D of the present modification is set to the same value as in the case of the microlens army 40A of the first embodiment, while a width W thereof is set to a value smaller than the height H.

That is, in the present modification, an outer shape of each of the condenser lens portion 340Ds1 and the projection lens portion 340Ds2 corresponding to the condenser lens portion 340Ds1 is set to have a vertically long rectangular shape in the lamp front view. Specifically, W is set to a value of about 0.4 to 0.8×H.

An entire periphery of an outer peripheral edge of the projection lens portion 340Ds2 of the microlens array 340D of the present modification is located on the same vertical plane which is orthogonal to the optical axis Ax. As a result, the projection lens portion 340Ds2 is set such that a curvature of a convex curve constituting a horizontal cross-sectional shape is larger than a curvature of a convex curve constituting a vertical cross-sectional shape by an amount by which the width W is smaller than the height H. The same also applies to the condenser lens portion 340Ds1.

As a result. a rear focus point Fh in the horizontal plane of the projection lens portion 340Ds2 is located on the lamp front side relative to the rear focus point F (see (a) of FIG. 5) in the vertical plane. A front focus point in the horizontal plane of the condenser lens portion 340Ds1 is located on the lamp rear side relative to the rear focus point Fh.

Therefore, the light from the light source unit 30 incident on the microlens array 340D from the condenser lens portion 340Ds1 is emitted from the corresponding projection lens portion 340Ds2 (that is, the projection lens portion located in the lamp front direction) to the lamp front side as light which is diffused in the left-right direction, and is emitted from the projection lens portions 340Ds2 adjacent to left and right sides of the corresponding projection lens portion 340Ds2 to the lamp front side with a large left-right direction diffusion angle.

In a case where the configuration of the present modification is adopted, the elongated light distribution pattern, in which the light distribution pattern PA formed by the light irradiated from the lamp unit 20A of the first embodiment is widely expanded in the left-right direction while the up-down width of the light distribution pattern PA is maintained, can still be formed while the brightness of the central region thereof is sufficiently ensured.

### Second Embodiment

Hereinafter, a second embodiment of the present disclosure will be described with reference to the drawings. Description of members having the same reference numerals as those already described in the description of the first embodiment will be omitted as appropriate for convenience of description.

FIG. 10 is a front view showing a vehicle lamp 1010 according to the second embodiment of the present disclosure FIG. 11 is a cross sectional view taken along line of FIG. 10, and FIG. 12 is a cross sectional view taken along line III-III of FIG. 10. In FIG. 10, a part of components are shown in a broken state.

As shown in these drawings, the vehicle lamp 1010 according to the present embodiment is a headlamp provided at the right front end portion of the vehicle, and has the configuration in which the three lamp units 20A, 20B, and 20C are incorporated in the housing formed by the lamp body 12 and the translucent cover 14 in the state of being aligned in the vehicle width direction.

The three lamp units 20A to 20C all have the same configuration and are configured to irradiate the light emitted from the light source unit 30 toward the lamp front side via microlens arrays 1040A, 1040B, and 1040C.

The microlens arrays 1040A to 1040C include rear lens arrays 1042A, 1042B, and 1042C, and front lens arrays 1044A, 1044B, and 1044C located on the lamp front side of the rear lens arrays 1042A, 1042B, and 1042C.

A front surface of each of the rear lens arrays 1042A to 1042C is configured by a flat surface extending along a vertical plane orthogonal to the optical axis Ax, while a plurality of condenser lens portions 1042As, 1042Bs, and 1042Cs configured to converge the light emitted from each light source unit 30 are formed on a rear surface of each of the rear lens arrays 1042A to 1042C. Each of the plurality of condenser lens portions 1042As to 1042Cs is a fish-eye lens which has a convex curved surface shape, and is allocated to each of a plurality of segments (for example, segments having a size of about 0.5 to 3 mm square) divided in a vertical and horizontal grid pattern.

Meanwhile, a rear surface of each of the front lens arrays 1044A to 1044C is configured by a flat surface extending along a vertical plane orthogonal to the optical axis Ax, while a plurality of projection lens portions 1044As, 1044Bs, and 1044Cs configured to project a plurality of light source images formed by the plurality of condenser lens portions 1042As to 1042Cs, respectively, are formed on a front surface of each of the front lens arrays 1044A to 1044C. Each of the plurality of projection lens portions 1044As to 1044Cs is a fish-eye lens which has a convex curved surface shape, and is allocated to each of a plurality of segments divided in a vertical and horizontal grid pattern with the same size as the condenser lens portions 1042As to 1042Cs.

Side end portions of the three rear lens arrays 1042A to 1042C are connected to each other. The three rear lens arrays 1042A to 1042C are configured as a rear translucent plate 42 which has a laterally long rectangular outer shape as a whole. On the rear translucent plate 42, a laterally long rectangular outer peripheral edge region 42a, which surrounds portions where the plurality of condenser lens portions 42As to 42Cs are formed on the three rear lens arrays 42A to 42C, is formed in a flat plate shape. The outer peripheral edge region 42a of the rear translucent plate 42 is supported by the lamp body 12.

Meanwhile, side end portions of the three front lens arrays 1044A to 1044C are also connected to each other. The three front lens arrays 1044A to 1011C are configured as a front translucent plate 44 which has the same outer shape as the rear translucent plate 42 as a whole. On the front translucent plate 44, a laterally long rectangular outer peripheral edge region 44a, which surrounds portions where the plurality of projection lens portions 1044As to 1044Cs are formed on the three front lens arrays 44A to 44C, is also formed in the flat plate shape.

A spatial light modulator 50 configured to control a spatial distribution of light that passes through the rear lens arrays 1042A to 1042C and is incident on the front lens arrays 1044A to 1044C is arranged between the rear lens arrays 1042A to 1042C and the front lens arrays 1044A to 1044C.

The spatial light modulator 50 is a light transmissive spatial light modulator having the same outer shape as the front translucent plate 44 and the rear translucent plate 42. The spatial light modulator 50 is formed in a panel shape, and includes a light control region 50a which has a laterally long rectangular shape. Specifically, the spatial light modulator 50 is configured by a transmissive liquid crystal display in which a plurality of light control elements 50s made of transmissive liquid crystal are arranged in a vertical and horizontal grid pattern in the light control region 50a.

The spatial light modulator 50 electrically controls a spatial distribution of the light from the light source unit 30 that has reached the light control region 50a, thereby controlling light emitted from the microlens arrays 1040A to 1040C.

An outer peripheral edge region 50b, which surrounds the light control region 50a, of the spatial light modulator 50 is sandwiched by the front translucent plate 44 and the rear translucent plate 42 from two sides in the lamp front-rear direction.

(a) of FIG. 13 is a detailed view of portion IVa shown in FIG. 11, (b) of FIG. 13 is a detailed view of portion IVb shown in FIG. 11, and (c) of FIG. 13 is a detailed view of portion IVc shown in FIG. 11. (a) of FIG. 14 is a detailed view of portion Va shown in FIG. 12, which shows a main part of the lamp unit 20A, and (b) and (c) of FIG. 14 show main parts of the lamp units 20B and 20C, respectively, in the same manner as (a) of FIG. 14. Further, (a) of FIG. 15 is a view taken in a direction of arrow VIa of (a) of FIG. 13, (b) of FIG. 15 is a view taken in a direction of arrow VIb of (b) of FIG. 13, and (c) of FIG. 13 is a view taken in a direction of arrow VIc of (c) of FIG. 13.

As shown in these drawings, the plurality of projection lens portions 1044As to 1044Cs formed on the front surfaces of the three front lens arrays 1044A to 1044C have spherical surface shapes having the same curvature. Specifically, the projection lens portions 1044As to 1044Cs have the optical axes Axa, Axb, and Axc which extend in the lamp front-rear direction, while the rear focus points F thereof are located in the vicinity of intersections between the optical axes Axa to Axc of the projection lens portions 1044As to 1044Cs and rear surfaces of the front lens arrays 1044A to 1044C.

The plurality of condenser lens portions 1042As to 1040Cs formed on the rear surfaces of the three rear lens arrays 1042A to 1042C are also arranged on the optical axes Axa to Axc of the corresponding projection lens portions 1044As to 1044Cs (that is, located in the lamp front direction of the condenser lens portions 1042As to 1040Cs, respectively).

As shown in (a) of FIG. 14, the condenser lens portion 1042As of the rear lens array 1042A has an arc-shaped vertical cross-sectional shape whose surface has a curvature smaller than that of the spherical surface constituting the surface of the projection lens portion 1044As, and a front focus point in a vertical plane thereof is located on the lamp front side relative to the rear focus point F of the projection lens portion 1044As.

As shown in (a) of FIG. 13, the condenser lens portion 1042As has an arc-shaped horizontal cross-sectional shape whose surface has a curvature smaller than that of the spherical surface constituting the surface of the projection lens portion 1044As, and a front focus point in a horizontal plane thereof is located on the lamp front side relative to the front focus point in the vertical plane.

As a result, as shown in (a1) of FIG. 15, the condenser lens portion 1042As forms the small and laterally long light source image IA on a rear focal plane of the projection lens portion 1044As. By performing light control by the spatial light modulator 50 based on the light source image IA, light is irradiated from toe projection lens portion 1044As to the lamp front side with a predetermined light distribution.

As shown in (b) of FIG. 14, the condenser lens portion 1042Bs of the rear lens array 1042B has an arc-shaped vertical cross-sectional shape whose surface has a curvature smaller than that of the spherical surface constituting the surface of the projection lens portion 1044Bs, and a front focus point in a vertical plane thereof is located on the lamp front side relative to the rear focus point F of the projection lens portion 1044Bs. A forward displacement amount in this case is larger than that in the case of the condenser lens portion 1042As of the rear lens array 1042A.

As shown in (b) of FIG. 13, the condenser lens portion 1042Bs has an arc-shaped horizontal cross-sectional shape whose surface has a curvature smaller than that of the spherical surface constituting the surface of the projection lens portion 1044Bs, and a front focus point in a horizontal plane thereof is located on the lamp front side relative to the front focus point in the vertical plane.

As a result, as shown in (b1) of FIG. 15, the condenser lens portion 1042Bs forms the laterally long light source image IB which has the medium size on a rear focal plane of the projection lens portion 1044Bs. By performing light control by the spatial light modulator 50 based on the light source image IB, light is irradiated from the projection lens portion 1044Bs to the lamp front side with a predetermined light distribution.

As shown in (c) of FIG. 14, the condenser lens portion 1042Cs of the rear lens array 1042C has an arc-shaped vertical cross-sectional shape whose surface has a curvature smaller than that of the spherical surface constituting the surface of the projection lens portion 1044Cs, and a front focus point in a vertical plane thereof is located on the lamp front side relative to the rear focus point F of the projection lens portion 1044Cs. A forward displacement amount in this case is further larger than that in the case of the condenser lens portion 1042Bs of the rear lens array 1042B.

As shown in (c) of FIG. 13, the condenser lens portion 1042Cs has an arc-shaped horizontal cross-sectional shape whose surface has a curvature smaller than that of the spherical surface constituting the surface of the projection lens portion 1044Cs, and a front focus point in a horizontal plane thereof is located on the lamp front side relative to the front focus point in the vertical plane.

As a result, as shown in (c1) of FIG. 15, the condenser lens portion 1042Cs forms die considerably large and laterally long light source image IC on a rear focal plane of the projection lens portion 1044Cs. By performing light control by the spatial light modulator 50 based on the light source image IC, light is irradiated from the projection lens portion 1044Cs to the lamp front side with a predetermined light distribution.

FIG. 16 transparently shows a light distribution pattern formed by light irradiated from the vehicle lamp 1010 on a virtual vertical screen arranged at a position 25 m ahead of the vehicle.

In this case, a light distribution pattern shown in (a) of FIG. 16 is a high-beam light distribution pattern PH1, while a light distribution pattern shown in (b) of FIG. 16 is an intermediate light distribution pattern (that is, an intermediate light distribution pattern between a high-beam light distribution pattern and a low-beam light distribution pattern) PM1 in which a part of the high-beam light distribution pattern PH1 is missing.

As shown in (a) of FIG. 16, the high-beam light distribution pattern PH1 is a laterally long light distribution pattern which is centered on the line V-V passing through H-V (the vanishing point in the lamp front direction) in the vertical direction and is widely spread in the horizontal direction. The high-beam light distribution pattern PH1 is formed as a combined light distribution pattern of three light distribution patterns PA1, PB1, and PC1.

The light distribution pattern PA1 is a light distribution pattern formed by the light irradiated from the lamp unit 20A as an inverted projection image of the light source image IA, and is formed as a small, bright and laterally long light distribution pattern centered on H-V. As a result, a high luminous intensity region of the high-beam light distribution pattern PH1 is formed.

The light distribution pattern PB1 is a light distribution pattern which is formed by the light irradiated from the lamp unit 20B as an inverted projection image of the light source image IB, and is formed concentrically with the light distribution pattern PA1 as a laterally long light distribution pattern which is slightly larger than the light distribution pattern PA1. As a result, an intermediate diffusion region of the high-beam light distribution pattern PH1 is formed.

The light distribution pattern PC1 is a light distribution pattern formed by the light irradiated from the lamp unit 20C as an inverted projection image of the light source image IC, and is formed concentrically with the light distribution pattern PA1 as a laterally long light distribution pattern which is further slightly larger than the light distribution pattern PB1. As a result, a high diffusion region of the high-beam light distribution pattern PH1 is formed.

As described above, since the high-beam light distribution pattern PH1 is formed as the combined light distribution pattern of the three types of light distribution patterns PA1, PB1, and PC1 which have different sizes and brightness, the high-beam light distribution pattern PH1 is a light distribution pattern having excellent distant visibility and less light distribution unevenness.

When the high-beam light distribution pattern PH1 is formed, as shown in (a1) to (c1) of FIG. 15, light shielding control is not performed by the spatial light modulator 50, and the light from the light source unit 30 that has reached the spatial light modulator 50 is directly irradiated from the projection lens portions 1044As to 1044Cs toward the lamp front side.

The intermediate light distribution pattern PM1 shown in (b) of FIG. 16 is a light distribution pattern in which an upper portion of the high-beam light distribution pattern PH1 is partially missing.

Specifically, the intermediate light distribution pattern PM1 is also formed as a combined light distribution pattern of three light distribution patterns PAm1, PBm1, and PCm1, and is formed as a light distribution pattern which has a substantially U-shaped recessed portion PM1a in which a partial region located on a right side of the line V-V of the high-beam light distribution pattern PH1 is cut by a rectangular cut-off line CL. In this case, the cut-off line CL is formed in such a manner that a lower end edge thereof is located slightly below line H-H which passes through H-V in the horizontal direction.

As shown in (a2), (b2), and (c2) of FIG. 15, the recessed portion PM1a is formed by partially bringing a part of the plurality of light control elements 50s constituting the light control region 50a of the spatial light modulator 50 into a light shielded state for each of the projection lens portions 1044As, 1044Bs, and 1044Cs.

Specifically, in the light control region 50a, a vertically long strip-shaped region 50a1 located on a left side (a right side in the lamp front view) of the optical axes Axa to Axc of the projection lens portions 1044As to 1044Cs is in the light shielded state. In this case, an upper end edge of the strip-shaped region 50a1 is located slightly above the optical axes Axa to Axc. The recessed portion PM1a is formed as an inverted projection image of the strip-shaped region 50a1.

By forming the intermediate light distribution pattern PM1 having such a recessed portion PM1a, the light irradiated from the vehicle lamp 1010 is prevented from being incident on an oncoming vehicle 2. As a result, a traveling path ahead is irradiated as widely as possible within a range in which no glare is given to a driver of the oncoming vehicle 2.

As a position of the oncoming vehicle 2 changes, a position of the strip-shaped region 50a1 of the light control region 50a of the spatial light modulator 50 is moved in the horizontal direction so as to move a position of the recessed portion PM1a in the horizontal direction, so that the state where the traveling path ahead is irradiated as widely as possible within the range in which no glare is given to the driver of the oncoming vehicle 2 is maintained.

In this case, presence of the oncoming vehicle 2 is detected by an in-vehicle camera or the like (not shown). Even in a case where a preceding vehicle is present on the traveling path ahead or a pedestrian is present on a road shoulder portion of the traveling path ahead, light control is performed by the spatial light modulator 50 upon detecting the presence of the preceding vehicle or the pedestrian such that no glare is given thereto.

Next, an operation of the present embodiment will be described.

The vehicle lamp 1010 according to the present embodiment includes the three lamp units 20A, 20B, and 20C, and each of the lamp units 20A to 20C is configured to form a required light distribution pattern by irradiating the light emitted from the light source unit 30 toward the lamp front side via the microlens arrays 1040A, 1040B, and 1040C. Since the spatial light modulator 50 which is configured to control the spatial distribution of the light that passes through the rear lens arrays 1042A to 1042C and is incident on the front lens arrays 1044A to 1044C is arranged between the rear lens arrays 1042A, 1042B and 1042C and the front lens arrays 1044A, 1044B and 1044C that constitute the microlens arrays 1040A to 1040C, a light distribution pattern having any shape and brightness as desired can be formed as the required light distribution pattern, and such shape and brightness can be changed over time.

Specifically, the high-beam light distribution pattern PH1 and the intermediate light distribution pattern PM1 in which the upper portion of the high-beam light distribution pattern PH1 is partially missing can be selectively formed as the required light distribution pattern. In this case, the position and a size of the recessed portion PM1a of the intermediate light distribution pattern PM1 can be changed in accordance with a vehicle traveling situation or the like.

As described above, according to the present embodiment, the vehicle lamp 1010 including the microlens arrays 1040A to 1040C can change the shape and the brightness of the light distribution pattern in accordance with the vehicle traveling situation or the like.

In addition, according to the present embodiment, since the spatial light modulator 50 is arranged along the vertical plane passing through the vicinity of the rear focus point F of each of the projection lens portions 1044As to 1044Cs that constitute the front lens arrays 1044A to 1044C, the cut-off line CL which forms a contour of the recessed portion PM1a can be formed clearly.

According to the present embodiment, since the spatial light modulator 50 is sandwiched by the front lens arrays 1044A to 1044C and the rear lens arrays 1042A to 1042C from the two sides in the lamp front-rear direction, positioning accuracy of the spatial light modulator 50 can be improved, and a lamp configuration can be simplified.

Further, according to the present embodiment, the rear lens arrays 1042A to 1042C are configured such that the front focus point of each of the condenser lens portions 1042As to 1042Cs is offset to the lamp front side relative to the rear focus point F of each of the corresponding projection lens portions 1044As to 1044Cs, and an amount of the offset is different far each of the projection lens portions 1044As to 1044Cs, so that the three types of light source images IA, IB, and IC having different sizes and brightness can be formed by the light which is emitted from the light source unit 30 and incident on the rear lens arrays 1042A to 1042C on the rear focal planes of the projection lens portions 1044As to 1044Cs. Therefore, the high-beam light distribution patient Pill and the intermediate light distribution pattern PM1 can be formed with less light distribution unevenness. As a result, visibility of the traveling path ahead of the vehicle can be excellent.

In addition, by adopting such a configuration, even in a simple configuration in which only the light shielding control is performed by the spatial light modulator 50 as the light control, the high-beam light distribution pattern PH1 and the intermediate light distribution pattern PM1 can still be formed with less light distribution unevenness.

Light transmittance control and the like may also be performed together with the light shielding control as the light control performed by the spatial light modulator 50. Of course, a light distribution pattern other than the high-beam light distribution pattern PH1 and the intermediate light distribution pattern PM1 (for example, a low-beam light distribution pattern whose upper portion has the cut-off line) may also be formed by the light control of the spatial light modulator 50.

Although the front focus point of each of the condenser lens portions 1042As to 1042Cs is offset to the lamp front side relative to the rear focus point F of each of the corresponding projection lens portions 1044As to 1044Cs over an entire region of each of the rear lens arrays 1042A to 1042C in the second embodiment, a configuration in which the offset to the lamp front side is only present in a part of the region may also be adopted.

Although the condenser lens portions 1042As to 1042Cs of the rear lens arrays 1042A to 1042C and the projection lens portions 1044As to 1044Cs of the front lens arrays 1044A to 1044C are allocated to each of the plurality of segments divided in the vertical and horizontal grid pattern in the second embodiment, it is also possible to adopt a division other than the vertical and horizontal grid pattern (for example, a division of an diagonal grid pattern).

### Modification of Second Embodiment

Next, a modification of the second embodiment will be described.

FIG. 17 shows a main part of a vehicle lamp according to the present modification in the same manner as FIG. 15.

As shown in FIG. 17, a basic configuration of the present modification is the same as that of the second embodiment. A single lamp unit 1120D having the same configuration as that of the lamp unit 20C of the second embodiment is provided, and not only the light shielding control but also the light transmittance control is performed by a spatial light modulator 150 as the light control, which is partially different from the second embodiment.

That is, the lamp unit 1120D of the present modification includes a microlens array 1140D similar to the microlens array 1040C of the second embodiment, and has a configuration in which a relatively large light source image ID (a light source image similar to the light source image IC of the second embodiment) is formed on a rear focal plane of each projection lens portion 1144Ds constituting a front lens array 1144D.

On the other hand, the spatial light modulator 150 of the present modification is configured such that a light control region 150a thereof can control light transmittance of a light control element 150s in a segment corresponding to each projection lens portion 1144Ds. FIG. 17 shows, as an example, a state where the light transmittance of the light control region 150a is set in three stages.

Specifically, a first region Z1 located at a center of the light source image ID (that is, a region located in the vicinity of an optical axis Axd of the projection lens portion 1144Ds) is set to have a highest light transmittance, a second region Z2 annularly surrounding the first region Z1 is set to have lower light transmittance than the first region Z1, and another third region Z3 is set to have still lower light transmittance.

As a result, the light source image ID is projected to the lamp front side by the projection lens portion 1144Ds as an image having three stages of brightness.

In FIG. 17, in the light control region 150a of the spatial light modulator 150, a vertically long strip-shaped region 150a1 located on a left side of the optical axis Axd of the projection lens portion 1144D is in the light shielded state.

FIG. 18 transparently shows an intermediate light distribution pattern PM2 formed by light irradiated from the vehicle lamp according to the present modification on a virtual vertical screen arranged at a position 25 m ahead of the vehicle.

The intermediate light distribution pattern PM2 is formed as a light distribution pattern having the same shape as that of the intermediate light distribution pattern PM1 of the second embodiment. In this case, portions corresponding to the three light distribution patterns PAm1, PBm1, and PCm1 constituting the intermediate light distribution pattern PM1 are formed as a first region Pm1, a second region Pm2, and a third region Pm3. The first to third regions Pm1 to Pm3 are formed as inverted projection images of the first region Z1 to Z3, respectively.

In the intermediate light distribution pattern PM2, a partial region located on the right side of the line V-V is also fanned as a substantially U-shaped recessed portion PM2a as an inverted projection image of the strip-shaped region 150a1.

In the case of adopting the configuration of the present modification, the intermediate light distribution pattern PM2 can also be formed in substantially the same manner as the intermediate light distribution pattern PM1 of the second embodiment.

In addition, in the present modification, the intermediate light distribution pattern PM2 can be achieved by the single lamp unit 1120D.

### Third Embodiment

Hereinafter, a third embodiment of the present disclosure will be described with reference to the drawings. Description of members having the same reference numerals as those already described in the description of the first embodiment and the second embodiment will be omitted as appropriate for convenience of description.

FIG. 19 is a front view showing a vehicle lamp 2010 according to the third embodiment of the present disclosure. FIG. 20 is a cross sectional view taken along line II-II of FIG. 19, and FIG. 21 is a cross sectional view taken along line III-III of FIG. 19. In FIG. 19, a part of components are shown in a broken state.

As shown in these drawings, the vehicle lamp 2010 according to the present embodiment is a lamp provided at a front end portion of the vehicle, and has a configuration in which a lamp unit 20 is incorporated in the housing formed by the lamp body 12 and the translucent cover 14.

The lamp unit 20 is configured to irradiate the light emitted from the light source unit 30 toward the lamp front side via a microlens array 2040.

The light source unit 30 includes the light source 32 and a translucent member 2034 arranged on the lamp front side thereof.

The translucent member 2034 includes the incident surface 34a on which the light from the light source 32 is incident, and the emission surface 34b from which the light incident from the incident surface 34a is emitted toward the lamp front side.

The incident surface 34a has a circular outer shape in the lamp front view.

The translucent member 2034 is configured as a colorless transparent resin molded article which has a rectangular (specifically, square) outer shape in the lamp front view. An outer peripheral flange portion 2034d of a flat plate portion 2034c extending along the emission surface 34b of the translucent member 2034 is supported by the lamp body 12.

The microlens array 2040 includes a rear lens array 2042 and a front lens array 2044 located on the lamp front side of the rear lens array 2042.

A front surface of the rear lens array 2042 is configured by a flat surface extending along a vertical plane orthogonal to the optical axis Ax, while a plurality of condenser lens portions 2042s configured to converge the light emitted from the light source unit 30 are formed on a rear surface of the rear lens array 2042 Each of the plurality of condenser lens portions 2042s is a fish-eye lens which has a convex curved surface shape, and is allocated to each of a plurality of segments (for example, segments having a size of about 0.5 to 3 mm square) divided in a vertical and horizontal grid pattern.

The rear leas array 2042 is configured as a colorless transparent resin molded article which has a rectangular (specifically, square) outer shape slightly larger than the translucent member 2034 in the lamp front view. A rectangular outer peripheral edge region 2042a of the rear lens array 2042, which surrounds portions where the plurality of condenser lens portions 2042s are formed, is formed in a flat plate shape. The outer peripheral edge region 2042a is supported by the lamp body 12.

Meanwhile, a rear surface of the front lens array 2044 is configured by a flat surface extending along a vertical plane orthogonal to the optical axis Ax, while a plurality of projection lens portions 2044s configured to project a plurality of light source images formed by the plurality of condenser lens portions 2042s are formed on a front surface of the front lens array 2044. Each of the plurality of projection lens portions 2044s is a fish-eye lens which has a convex curved surface shape, and is allocated to each of a plurality of segments divided in a vertical and horizontal grid pattern with the same size as the condenser lens portions 2042s.

The front lens array 2044 is also configured as a colorless transparent resin molded article which has substantially the same outer shape as the rear lens array 2042. A rectangular outer peripheral edge region 44a which surrounds portions where the plurality of projection lens portions 2044s are formed is formed in a flat plate shape.

A light shielding plate 2050 configured to define a shape of each of the plurality of light source images formed by the plurality of condenser lens portions 2042s, and a color filter 60 configured to change a color of light emitted from the microlens array 2040 to a color different from a color of the light emitted from the light source unit 30 (that is, a color other than white) are arranged between the rear lens array 2042 and the front lens array 2044.

The light shielding plate 2050 is formed of a thin plate (for example, a metal plate having a thickness of about 0.1 to 0.5 mm) having substantially the same outer shape as the rear translucent plate 2042 and the front translucent plate 2044. A plurality of opening portions 2050a are regularly formed in the light shielding plate 2050. Specifically, the plurality of opening portions 2050a are arranged in the vertical and horizontal grid pattern so as to correspond to the plurality of projection lens portions 2044s of the front lens array 2044.

FIG. 22 is a detailed view of portion IV shown in FIG. 21, and FIG. 23 is a view taken in a direction of arrow V of FIG. 22.

As shown in these drawings, the plurality of projection lens portions 2044s formed on the front surface of the front lens array 2044 have spherical surface shapes having the same curvature. Specifically, each projection lens portion 2044s has an optical axis Ax4 extending in the lamp front-rear direction, while the rear focus point F thereof is located in the vicinity of an intersection between the optical axis Ax4 of the projection lens portion 2044s and a rear surface of each front lens array 2044.

As shown in FIG. 23, the plurality of opening portions 2050a formed in the light shielding plate 2050 have the same shape. Specifically, each opening 2050a is formed in a downward arrow shape at a position directly above the optical axis Ax4 of each projection lens portion 2044s.

The light shielding plate 2050 shields a part of the light from the light source unit 30 that has reached the light shielding plate 2050 via each condenser lens portion 2042s, thereby forming a light source image having the arrow shape defined by each opening portion 2050a on a rear focal plane of each projection lens portion 2044s, and the light source image is reversed and projected by each projection lens portion 2044s.

As shown in FIG. 22, the plurality of condenser lens portions 2042s formed on the rear surface of the rear lens array 2042 also have an optical axis Ax2 extending in the lamp front-rear direction, and the optical axis Ax2 is offset upward relative to the optical axis Ax4 of the corresponding projection lens portion 2044s (that is, the projection lens portion 2044s located in the lamp front direction). In this case, an upward displacement amount D from the optical axis Ax4 is set to a value of, for example, about ¼ to ⅓ of an up-down width of the projection lens portion 44s.

A surface of each condenser lens portion 2042s has a spherical surface shape whose curvature is smaller than that of the spherical surface constituting the surface of the projection lens portion 2044s, and a front focus point thereof is located far on the lamp front side relative to the rear focus point F of the projection lens portion 2044s (specifically, on the lamp front side relative to the projection lens portion 2044s). As a result, the light from the light source unit 30 that has reached the light shielding plate 2050 via each condenser lens portion 2042s is irradiated to a region covering each opening portion 2050a.

In this case. since the optical axis Ax2 of each condenser lens portion 2042s is offset upward relative to the optical axis Ax4 of each projection lens portion 2044s, an amount of light shielded by the light shielding plate 2050 is reduced as compared with a case where the upward offset is not present.

The color filter 60 is formed of a green color film attached to a rear surface of the light shielding plate 2050. The color filter 60 has a rectangular outer shape slightly smaller than the outer shape of the light shielding plate 2050.

Outer peripheral edge regions of the light shielding plate 2050 and the color filter 60 are sandwiched by the front translucent plate 2044 and the rear translucent plate 2042 from two sides in the lamp front-rear direction.

FIG. 24 transparently shows a light distribution pattern for road surface drawing PAr formed by light irradiated from the vehicle lamp 2010 on a virtual vertical screen arranged at a position 25 m ahead of the vehicle.

The light distribution pattern for road surface drawing PAr is formed together with a low-beam light distribution pattern PL formed by light irradiated from another vehicle lamp (not shown).

Before describing the light distribution pattern for road surface drawing PAr, the low-beam light distribution pattern PL will be described.

The low-beam light distribution pattern PL is a low-beam light distribution pattern of left light distribution, and an upper end edge thereof has cut-off lines CL1 and. CL2.

As for the cutoff lines CL1 and CL2, an oncoming lane side portion on the right side of the line V-V passing through the H-V (the vanishing point in the lamp front direction) in the vertical direction is formed as the horizontal cut-off line CL1, and an own lane side portion on the left side of the V-V line is formed as the oblique cut-off line CL2. An elbow point E, which is an intersection between the cutoff lines CL1 and CL2, is located about 0.5° to 0.6° below the H-V.

The light distribution pattern for road surface drawing PAr is a light distribution pattern that performs road surface drawing so as to call attention to surroundings, and is formed as a light distribution pattern that draws an arrow facing the vehicle front direction on a road surface ahead of the vehicle.

The light distribution pattern for road surface drawing PAr is formed as an inverted projection image of the plurality of opening portions 2050a formed in the light shielding plate 2050.

The light distribution pattern for road surface drawing PAr is located below the elbow point E on the line V-V. This is because each opening portion 2050a is formed at a position directly above the optical axis Ax4 of each projection lens portion 2044s.

By forming such an arrow-shaped light distribution pattern for road surface drawing PAr when the vehicle is traveling at night, for example, it is possible to notify the surroundings that the own vehicle is approaching an intersection ahead of the vehicle and thus attract attention.

A position where the light distribution pattern for road surface drawing PAr is formed on the road surface ahead of the vehicle can be appropriately set by adjusting the amount of upward displacement of each opening portion 2050a from the optical axis Ax4.

Next, an operation of the present embodiment will be described.

The vehicle lamp 2010 according to the present embodiment is configured to form the required light distribution pattern by irradiating the light emitted from the light source unit 30 toward the lamp front side via the microlens array 2040. Since the light shielding plate 2050 configured to define the shape of each of the plurality of light source images formed by the plurality of condenser lens portions 2042s is arranged between the rear lens array 2042 and the front lens array 2044 constituting the microlens array 2040, it is possible to appropriately set an opening shape of the light shielding plate 2050 so as to form the light distribution pattern for road surface drawing PAr by the light emitted from the microlens array 2040.

At this time, since the color filter 60 configured to change the color of the light emitted from the microlens array 2040 to the color different from the color of the light emitted from the light source unit 30 is arranged between the rear lens array 2042 and the front lens array 2044, the color filter 60 can form the light distribution pattern for road surface drawing PAr in a color different from a normal light distribution pattern (that is, a light distribution pattern formed by a headlamp, a fog lamp, or the like), and thus a function of attracting attention to the surroundings can be improved.

As described above, according to the present embodiment, the vehicle lamp 2010 including the microlens array 2040 can form, by a simple lamp configuration, the light distribution pattern for road surface drawing PAr whose function of attracting attention to the surroundings is excellent.

In particular, in the present embodiment, since the color filter 60 is formed of the color film attached to the light shielding plate 2050, the lamp configuration can be further simplified. In addition, since the color filter 60 is formed of the green color film the light distribution pattern for road surface drawing PAr can be formed in a color completely different from the normal light distribution pattern and in a color completely different from a lighting color of a tail lamp, a turn signal lamp, or the like. Therefore, the function of attracting attention to the surroundings can be improved without causing unnecessary misrecognition.

In the present embodiment, since the light shielding plate 2050 and the color filter 60 are sandwiched by the front lens array 2044 and the rear lens array 2042 from the two sides in the lamp front-rear direction, positioning accuracy of the light shielding plate 2050 and the color filter 60 can be improved, and the lamp configuration can be further simplified.

Further, in the present embodiment, since the optical axis Ax2 of each condenser lens portion 2042s of the rear lens array 2042 is offset upward relative to the optical axis Ax4 of the projection lens portion 2044s corresponding to the condenser lens portion 2042s, most of the light emitted from the microlens array 2040 can be downward light, and thus the light distribution pattern for road surface drawing PAr can be efficiently formed.

In the present embodiment, since the front focus point of each condenser lens portion 2042s of the rear lens array 2042 is offset to the lamp front side relative to the rear focus point F of the projection lens portion 2044s corresponding to the condenser lens portion 2042s, a relatively large light source image can be formed by the light which is emitted from the light source unit 30 and incident on the rear lens array 2042 on the rear focal plane of the projection lens portion 2044s, and thus the light distribution pattern for road surface drawing PAr can be easily formed with a required size.

Although the color filter 60 is formed of the green color film in the third embodiment, it is of course possible that the filter 60 is formed of a color film having a color other than green.

Although the color filter 60 is formed of the color film attached to the rear surface of the light shielding plate 2050 in the third embodiment, the color filter 60 may also be formed of a color film attached to a front surface of the light shielding plate 2050, and the color filter 60 may also be formed of a translucent plate or the like.

Although the light distribution pattern for road surface drawing PAr is formed together with the low-beam light distribution pattern PL in the third embodiment, it is also possible that the light distribution pattern for road surface drawing PAr is formed together with a high-beam light distribution pattern, or only the light distribution pattern for road surface drawing PAr is formed.

Although the condenser lens portions 2042s of the rear lens array 2042 and the projection lens portions 2044s of the front lens array 2044 are allocated to each of the plurality of segments divided in the vertical and horizontal grid pattern in the third embodiment, it is also possible to adopt a division other than the vertical and horizontal grid pattern (for example, a division of an diagonal grid pattern).

### First Modification of Third Embodiment

Next, modifications of the third embodiment will be described.

First, a first modification of the third embodiment will be described.

FIG. 25 shows a main part of a vehicle lamp according to the present modification in the same manner as FIG. 23.

As shown in FIG. 25, a basic configuration of the present modification is the same as that of the third embodiment, except that a shape of each of a plurality of opening portions 2150a formed in a light shielding plate 2150 is different from that of the third embodiment.

That is, in the present modification, the plurality of opening portions 2150a formed in the light shielding plate 2150 are also arranged in the vertical and horizontal grid pattern so as to correspond to the plurality of projection lens portions 2044s of the front lens array 2044, while each opening portion 2150a of the present modification includes three opening portions 2150aC, 2150aL, and 2150aR which are formed in vertically long rectangular shapes.

The three opening portions 2150aC, 2150aL, and 2150aR are formed at equal intervals in the left-right direction. In this case, the opening portion 2150aC which is located at the center is located directly above the optical axis Ax4 of each projection lens portion 2044s.

The light shielding plate 2150 shields a part of the light from the light source unit 30 that has reached the light shielding plate 2150 via each condenser lens portion 2042s, thereby forming three vertically long rectangular light source images defined by the three opening portions 2150aC, 2150aL, and 2150aR constituting each opening portion 2150a on the rear focal plane of each projection lens portion 2044s, and the light source images are reversed and projected by each projection lens portion 2044s.

FIG. 26 transparently shows a light distribution pattern for road surface drawing PBr formed by light irradiated from the vehicle lamp according to the present modification on a virtual vertical screen arranged at a position 25 m ahead of the vehicle.

The light distribution pattern for road surface drawing PBr includes three light distribution patterns PBrC, PBrL, and PBrR which extend in strip shapes toward the vehicle front direction on a road surface ahead of the vehicle.

In this case, the light distribution pattern PBrC is a light distribution pattern formed as an inverted projection image of the opening portion 2150aC located in the center of each opening portion 2150a, and is formed to be located below the elbow point E on the line V-V.

The light distribution pattern PBrL is formed to be located on a left side of the light distribution pattern PBrC as an inverted projection image of the opening portion 2150aR located on a right side in each opening portion 2150a, and the light distribution pattern PBrR is formed to be located on a right side of the light distribution pattern PBrC as an inverted projection image of the opening portion 2150aL located on a left side in each opening portion 2150a.

When the configuration of the present modification is adopted, the green light distribution pattern for road surface drawing PBr can still be formed on the road surface ahead of the vehicle, and thus the function of attracting attention to the surroundings can be improved.

### Second Modification of Third Embodiment

Next, a second modification of the third embodiment will be described.

FIG. 27 shows a vehicle lamp 2210 according to the present modification in the same manner as FIG. 19.

As shown in FIG. 27, a basic configuration of the present modification is the same as that of the third embodiment, except that a configuration of a lamp unit 2220 is partially different from that of the third embodiment

That is, the present modification is different from the third embodiment in shapes of a plurality of opening portions 2250a, 2250b, and 2250c formed in a light shielding plate 2250, and is also different from the third embodiment in that three color filters 260A, 260B, and 260C are provided.

In the present modification, the plurality of opening portions 2250a, 2250b, and 2250c formed in the light shielding plate 2250 are still arranged in the vertical and horizontal grid pattern so as to correspond to the plurality of projection lens portions 2044s of the front lens array 2044, while the plurality of opening portions 2250a, 2250b, and 2250c are each formed as an opening portion having the same shape as one of the three opening portions 2150aC, 2150aL and 2150aR of the first modification of the third embodiment in each region obtained by dividing the light shielding plate 2250 into three in the up-down direction.

Specifically, each opening portion 2250a formed in a central region of the light shielding plate 2250 is formed at the same position as each opening portion 2150aC of the first modification of the third embodiment, each opening portion 2250b formed in an upper region of the light shielding plate 2250 is formed at the same position as each opening portion 2150aL of the first modification, and each opening portion 2250c formed in a lower region of the light shielding plate 2250 is formed at the same position as each opening portion 2150aR of the first modification.

The three color filters 260A, 260B, and 260C are formed of three color films attached to rear surfaces of the respective regions obtained by dividing the light shielding plate 2250 into three in the up-down direction, and are formed of color films having different colors.

Specifically, the color filter 260A arranged in the central region of the light shielding plate 2250 is formed of a green color film, the color filter 260B arranged in the upper region of the light shielding plate 2250 is formed of a blue color film, and the color filter 260C arranged in the lower region of the light shielding plate 2250 is formed of a purple color film.

As a result, light emitted from a central region of the microlens array 2040 is changed to green by the color filter 260A, light emitted from an upper region of the microlens array 2040 is changed to blue by the color filter 260B, and light emitted from a lower region of the microlens array 2040 is changed to purple by the color filter 260C.

FIG. 28 transparently shows a light distribution pattern for road surface drawing PCr formed by light irradiated from the vehicle lamp according to the present modification on a virtual vertical screen arranged at a position 25 m ahead of the vehicle.

The light distribution pattern for road surface drawing PCr includes three light distribution patterns PCra, PCrb, and PCrc which extend in strip shapes toward the vehicle front direction on the road surface ahead of the vehicle.

The light distribution pattern PCra is a light distribution pattern formed as an inverted projection image of the plurality of opening portions 2250a formed in the central region of the light shielding plate 2250, and is formed to be located below the elbow point E on the line V-V.

The light distribution pattern PCrb is a light distribution pattern formed as an inverted projection image of the plurality of opening portions 2250b formed in the upper region of the light shielding plate 2250, and is formed to be located on a right side of the light distribution pattern PCra.

The light distribution pattern PCrc is a light distribution pattern formed as an inverted projection image of the plurality of opening portions 2250c formed in the lower region of the light shielding plate 2250, and is formed to be located on a left side of the light distribution pattern PCra.

In this case, the light distribution pattern PCra is formed as a green light distribution pattern, the light distribution pattern PCrb is formed as a blue light distribution pattern, and the light distribution pattern PCrc is formed as a purple light distribution pattern.

When the configuration of the present modification is adopted, the light distribution pattern for road surface drawing PCr can still be formed on the road surface ahead of the vehicle in colors different from that of the normal light distribution pattern, and thus the function of attracting attention to the surroundings can be improved.

In this case, in the present modification, since the light distribution pattern for road surface drawing PCr is formed in three colors including green, blue, and purple, the function of attracting attention to the surroundings can further be improved.

Although the three color filters 260A, 260B, and 260C are formed of green, blue, and purple color films in the second modification of the third embodiment, a combination of colors other than green, blue, and purple may also be adopted.

### Third Modification of Third Embodiment

Next, a third modification of the third embodiment will be described.

FIG. 29 shows a main part of a vehicle lamp according to the present modification in the same manner as FIG. 22.

As shown in FIG. 29, a basic configuration of the present modification is the same as that of the third embodiment, except that configurations of a light shielding plate 2350 and a color filter 360 are different from those of the third embodiment.

That is, in the present modification, the color filter 360 is formed of a green translucent plate, and the light shielding plate 2350 is formed by forming a light shielding film 2350b on a front surface of the color filter 360.

The light shielding film 2350b is formed by performing a light shielding process such as black coating on the front surface of the color filter 360. At this time, a plurality of opening portions 2350a are formed in the light shielding plate 2350 as regions where the light shielding process is not performed.

As in the case of the third embodiment, the plurality of opening portions 2350a are arranged in the vertical and horizontal grid pattern so as to correspond to the plurality of projection lens portions 2044s of the front lens array 2044. Each opening portion 2350a is formed in a downward arrow shape at a position directly above the optical axis Ax4 of each projection lens portion 2044s.

When the configuration of the present modification is adopted, the arrow-shaped light distribution pattern for road surface drawing can still be formed on the road surface ahead of the vehicle as a green light distribution pattern, and thus the function of attracting attention to the surroundings can be improved.

In addition, the configuration as in the present modification in which the light shielding plate 2350 and the color filter 360 are integrally formed can further simplify the lamp configuration.

### Fourth to Sixth Modifications of Third Embodiment

Next, fourth to sixth modifications of the third embodiment will be described.

FIGS. 30A to 30C schematically show lamp units 2420, 2520, and 2620 of vehicle lamps according to the fourth to sixth modifications, respectively, in substantially the same manner as FIG. 19.

As shown in FIGS. 30A to 30C, basic configurations of the fourth to sixth modifications are the same as that of the third embodiment, except that outer shapes of microlens arrays 2440, 2540, and 2640 are different from that of the third embodiment

That is, as shown in FIG. 19, the micro/lens army 2040 according to the third embodiment has the square outer shape which is larger than an outer shape of the emission surface 34b of the translucent member 2034 of the light source unit 30 (that is, the same circular outer shape as the incident surface 34a).

In contrast, as shown in FIG. 30A, the microlens army 2440 of the lamp unit 2420 according to the fourth modification has a square outer shape located between a position inscribed and a position circumscribed relative to the outer shape of the emission surface 34b of the translucent member 2034. As shown in FIG. 30B, the microlens array 2540 of the lamp unit 2520 according to the fifth modification has an equilateral triangular outer shape located between the position inscribed and the position circumscribed relative to the outer shape of the emission surface 34b of the translucent member 2034.

By adopting such configurations, most of the light emitted from the light source unit 30 can be emitted toward the lamp front side via the microlens arrays 2440 and 2540 without excessively increasing the outer shapes of the microlens arrays 2440 and 2540.

Meanwhile, as shown in FIG. 30C. the microlens array 2640 of the lamp unit 2620 according to the sixth modification has a circular outer shape having substantially the same size as the outer shape of the emission surface 34b of the translucent member 2034.

By adopting such a configuration, the light emitted from the light source unit 30 can be emitted toward the lamp front side via the microlens array 2640 while the outer shape of the microlens array 2640 is minimized.

### Fourth Embodiment

Hereinafter, a fourth embodiment of the present disclosure will be described with reference to the drawings. Description of members having the same reference numerals as those already described in the description of the first to third embodiments will be omitted as appropriate for convenience of description.

FIG. 31 is a front view showing a vehicle lamp 3010 according to the fourth embodiment of the present disclosure. FIG. 32 is a cross sectional view taken along line II-II of FIG. 31, and FIG. 33 is a cross sectional view taken along line III-III of FIG. 31. In FIG. 31, a part of components are shown in a broken state.

As shown in these drawings, the vehicle lamp 3010 according to the present embodiment is a headlamp provided at the right front end portion of the vehicle, and has a configuration in which three lamp units 3020A, 3020B, and 3020C are incorporated in the housing formed by the lamp body 12 and the translucent cover 14 in the state of being aligned in the vehicle width direction.

The three lamp units 3020A to 3020C all have the same configuration and are configured to irradiate the light emitted from the light source unit 30 toward the lamp front side via microlens arrays 3040A, 3040B, and 3040C.

The microlens arrays 3040A to 40C include rear lens arrays 3042A, 3042B, and 3042C, and front lens arrays 3044A, 3044B, and 3044C located on the lamp front side of the rear lens arrays 3042A, 3042B, and 3042C.

A front surface of each of the rear lens arrays 3042A to 3042C is configured by a flat surface extending along a vertical plane orthogonal to the optical axis Ax, while a plurality of condenser lens portions 3042As, 3042Bs, and 3042Cs configured to converge the light emitted from each light source unit 30 are formed on a rear surface of each of the rear lens arrays 3042A to 3042C. Each of the plurality of condenser lens portions 3042As to 3042Cs is a fish-eye lens which has a convex curved surface shape, and is allocated to each of a plurality of segments (for example, segments having a size of about 0.5 to 3 mm square) divided in a vertical and horizontal grid pattern.

Meanwhile, a rear surface of each of the front lens arrays 3044A to 3044C is configured by a flat surface extending along a vertical plane orthogonal to the optical axis Ax, while a plurality of projection lens portions 3044As, 3044Bs, and 3044Cs configured to project a plurality of light source images formed by the plurality of condenser lens portions 3042As to 3042Cs, respectively, are formed on a front surface of each of the front lens arrays 3044A to 3044C. Each of the plurality of projection lens portions 3044As to 3044Cs is a fish-eye lens which has a convex curved surface shape, and is allocated to each of a plurality of segments divided in a vertical and horizontal grid pattern with the same size as the condenser lens portions 3042As to 3042Cs.

Side end portions of the three rear lens arrays 3042A to 3042C are connected to each other. The three rear lens arrays 3042A to 3042C are configured as a rear translucent plate 3042 which has a laterally long rectangular outer shape as a whole. On the rear translucent plate 3042, the laterally long rectangular outer peripheral edge region 42a, which surrounds portions where the plurality of condenser lens portions 3042As to 3042Cs are formed on the three rear lens arrays 3042A to 3042C, is formed in the flat plate shape. The outer peripheral edge region 42a of the rear translucent plate 3042 is supported by the lamp body 12.

Meanwhile, side end portions of the three front lens arrays 3044A to 3044C are also connected to each other. The three front lens arrays 3044A to 3044C are configured as a front translucent plate 3044 which has the same outer shape as the rear translucent plate 3042 as a whole. On the front translucent plate 3044, the laterally long rectangular outer peripheral edge region 44a, which surrounds portions where the plurality of projection lens portions 3044As to 3044Cs are formed on the three front lens arrays 3044A to 3044C, is also formed in the flat plate shape.

A light shielding plate 3050 is arranged between the rear lens arrays 3042A to 3042C and the front lens arrays 3044A to 3044C so as to define a shape of each of the plurality of light source images formed by each of the plurality of condenser lens portions 3042As to 3042Cs.

The light shielding plate 3050 is formed of a thin plate (for example, a metal plate having a thickness of about 0.1 to 0.5 mm) having substantially the same outer shape as the rear translucent plate 3042 and the front translucent plate 3044. A plurality of opening portions 3050a are regularly formed in the light shielding plate 3050. Specifically, the plurality of opening portions 3050a are arranged in the vertical and horizontal grid pattern so as to correspond to the plurality of projection lens portions 3044As to 3044Cs of the front lens arrays 3044A to 3044C.

(a) of FIG. 34 is a detailed view of portion IVa shown in FIG. 32, (b) of FIG. 34 is a detailed view of portion IVb shown in FIG. 32, and (c) of FIG. 34 is a detailed view of portion IVc shown in FIG. 32. (a) of FIG. 35 is a detailed view of portion Va shown in FIG. 33, which shows a main part of the lamp unit 3020A, and (b) and (c) of FIG. 35 show main parts of the lamp units 3020B and 3020C, respectively, in the same manner as (a) of FIG. 35. FIG. 36 is a view taken in a direction of arrow VI of FIG. 34.

As shown in these drawings, the plurality of projection lens portions 3044As to 3044Cs formed on the front surfaces of the three front lens arrays 3044A to 3044C have spherical surface shapes having the same curvature. Specifically, the projection lens portions 3044As to 3044Cs have the optical axes Axa4, Axb4, and Axc4 which extend in the lamp front-rear direction, while the rear focus points F thereof are located in the vicinity of intersections between the optical axes Axa4 to Axc4 of the projection lens portions 3044As to 3044Cs and rear surfaces of the front lens arrays 3044A to 3044C.

As shown in FIG. 36, the plurality of opening portions 3050a formed in the light shielding plate 3050 have the same shape. Specifically, each opening portion 3050a is formed in a substantially laterally long rectangular shape. A portion of a lower end edge 3050a1 of the opening portion 3050a, which is located on a left side (a right side in the lamp front view) relative to the optical axis Axa of the projection lens portion 3044As, extends slightly above the optical axis Axa4 in the horizontal direction, while a portion located on a right side relative to the optical axis Axa4 extends obliquely rightward and downward from an intersection between the portion on the left side and a vertical plane including the optical axis Axa4. An upper end edge of each opening portion 3050a is located slightly below an upper end edge of each projection lens portion 3044As. Two side end edges of each opening portion 3050a are located substantially on inner sides of two side end edges of each projection lens portion 3044As.

The lower end edge 50a1 of the opening portion 3050a of the light shielding plate 3050 shields a part of the light from the light source unit 30 that has reached the light shielding plate 3050 via the condenser lens portion 3042As, so that a light source image whose lower end portion has a light-shade boundary line is formed on a rear focal plane of the projection lens portion 3044As.

The plurality of condenser lens portions 3042As to 3040Cs formed on the rear surfaces of the three rear lens arrays 3042A to 3042C also have optical axes Axa2, Axb2, and Axc2 which extend in the lamp front-rear direction. The optical axes Axa2 to Axc2 are offset upward and in the left-right direction relative to the optical axes Axa4 to Axc4 of the corresponding projection lens portions 3044As to 3044Cs (that is, the projection lens portion located in the lamp front direction).

That is, as shown in FIG. 36 and (a) of FIG. 35, the optical axis Axa2 of the condenser lens portion 3042As of the rear lens array 3042A is offset upward relative to the optical axis Axa4 of the projection lens portion 3044As.

As shown in FIG. 36 and (a) of FIG. 34, in a left region 3042AL located on a left side relative to the optical axis Ax of the light source unit 30 of the rear lens array 3042A, the optical axis Axa2 of the condenser lens portion 3042As of the rear lens array 3042A is offset rightward relative to the optical axis Axa4 of the projection lens portion 3044As. In a right region 3042AR located on a right side relative to the optical axis Ax, the optical axis Axa2 is offset leftward relative to the optical axis Axa4 of the projection lens portion 3044As. In this case, an amount DHaL of the rightward offset of the left region 3042AL and an amount DHaR of the leftward offset of the right region 3042AR are set to the same value.

As shown in (b) of FIG. 35, the optical axis Axb2 of the condenser lens portion 3042Bs of the rear lens array 3042B is offset upward relative to the optical axis Axb4 of the projection lens portion 3044Bs. In this case, an amount DVb of the upward offset of the optical axis Axb2 of the condenser lens portion 3042Bs is set to a value larger than an amount DVa of offset in the case of the condenser lens portion 3042As.

As shown in (b) of FIG. 34, in a left region 3042BL located on the left side relative to the optical axis Ax of the light source unit 30 of the rear lens array 3042B, the optical axis Axb2 of the condenser leas portion 3042Bs of the rear lens array 3042B is offset rightward relative to the optical axis Axb4 of the projection lens portion 3044Bs. In a right region 3042BR located on the right side relative to the optical axis Ax, the optical axis Axb2 is offset leftward relative to the optical axis Axb4 of the projection lens portion 3044Bs. In this case, an amount DHbL of the rightward offset of the left region 3042BL and an amount DHbR of the leftward offset of the right region 3042BR are set to the same value.

As shown in (c) of FIG. 35, the optical axis Axc2 of the condenser lens portion 3042Cs of the rear lens array 3042C is offset upward relative to the optical axis Axc4 of the projection lens portion 3044Cs. In this case, an amount DVc of the upward offset of the optical axis Axc2 of the condenser lens portion 3042Cs is set to a value still larger than the amount DVb of the offset in the case of the condenser lens portion 3042Bs.

As shown in (c) of FIG. 34, in a left region 3042CL located on the left side relative to the optical axis Ax of the light source unit 30 of the rear lens array 3042C, the optical axis Axc2 of the condenser lens portion 3042Cs of the rear lens array 3042C is offset rightward relative to the optical axis Axc4 of the projection lens portion 3044Cs. In a right region 3042CR located on the right side relative to the optical axis Ax, the optical axis Axc2 is offset leftward relative to the optical axis Axc4 of the projection lens portion 3044Cs. In this case, an amount DHcL of the rightward offset of the left region 3042CL and an amount DHcR of the leftward offset of the right region 3042CR are set to the same value.

As described above, although a left-right width of each of the condenser lens portions 3042As to 3042Cs is constant, due to the left-right direction offset, a left-right width of each of the condenser lens portions 3042As to 3042Cs adjacent to each of the optical axes Axa2 to Axc2 on left and right sides is slightly narrower as compared with each of the other condenser lens portions 3042As to 3042Cs.

As shown in (a) of FIG. 35, the condenser lens portion 3042As of the rear lens array 3042A has an arc-shaped vertical cross-sectional shape whose surface has a curvature smaller than (or substantially equal to) that of the spherical surface constituting the surface of the projection lens portion 3044As, and a front focus point in a vertical plane thereof is located on the lamp front side relative to the rear focus point F (or in the vicinity of the rear focus point F) of the projection lens portion 3044As.

As a result, the condenser lens portion 3042As forms a small light source image on the rear focal plane of the projection lens portion 3044As. Although a lower end portion of the light source image has a light-shade boundary line, since the optical axis Axa2 of the condenser lens portion 3042As is offset upward relative to the optical axis Axa4 of the projection lens portion 3044As, an amount of light shielded by the light shielding plate 3050 is reduced as compared with a case where the upward offset is not present, and thus a bright light source image is formed.

As shown in (b) of FIG. 35, the condenser lens portion 3042Bs of the rear lens array 3042B has an arc-shaped vertical cross-sectional shape whose surface has a curvature smaller than that of the spherical surface constituting the surface of the projection lens portion 3044Bs, and a front focus point in a vertical plane thereof is located on the lamp front side relative to the rear focus point F of the projection lens portion 3044Bs. A forward displacement amount in this case is larger than that in the case of the condenser lens portion 3042As of the rear lens array 3042A.

As a result, the condenser lens portion 3042Bs forms a light source image which has a medium size on the rear focal plane of the projection lens portion 3044Bs. Although a lower end portion of the light source image has a light-shade boundary line, since the amount DVb of the upward offset of the optical axis Axb2 of the condenser lens portion 3042Bs is set to the value larger than the amount DVa of the offset of the condenser lens portion 3042As, the amount of light shielded by the light shielding plate 3050 is reduced as compared with a case where the upward offset is not present even though the forward displacement amount of the front focus point is large, and thus the bright light source image is formed.

As shown in (c) of FIG. 35, the condenser lens portion 3042Cs of the rear lens array 3042C has an arc-shaped vertical cross-sectional shape whose surface has a curvature smaller than that of the spherical surface constituting the surface of the projection lens portion 3044Cs, and a front focus point in a vertical plane thereof is located on the lamp front side relative to the rear focus point F of the projection lens portion 3044Cs. A forward displacement amount in this case is further larger than that in the case of the condenser lens portion 3042Bs of the rear lens array 3042B.

As a result, the condenser lens portion 3042Cs forms a relatively large light source image on the rear focal plane of the projection lens portion 3044Cs. Although a lower end portion of the light source image has a light-shade boundary line, since the amount DVc of the upward offset of the optical axis Axc2 of the condenser lens portion 3042Cs is set to the value further larger than the amount DVb of the offset of the condenser lens portion 3042Bs, the amount of light shielded by the light shielding plate 3050 is reduced as compared with a case where the upward offset is not present even though the forward displacement amount of the front focus point is further larger, and thus the bright light source image is formed.

As shown in (a) of FIG. 34, the condenser lens portion 3042As of the rear lens array 3042A has an arc-shaped horizontal cross-sectional shape whose surface has a curvature slightly smaller than (or substantially equal to) that of the spherical surface constituting the surface of the projection lens portion 3044As, and a front focus point in a horizontal plane thereof is located slightly on the lamp front side relative to the rear focus point F (or in the vicinity of the rear focus point F) of the projection lens portion 3044As.

As a result, in the left region 3042AL of the rear lens array 3042A, the light emitted from each projection lens portion 3044As is slightly diffused in the horizontal direction substantially leftward relative to the optical axis Ax. In the right region 3042AR of the rear lens array 3042A, the light emitted from each projection lens portion 3044As is slightly diffused in the horizontal direction substantially rightward relative to the optical axis Ax.

As shown in (b) of FIG. 34, the condenser lens portion 3042Bs of the rear lens array 3042B has an arc-shaped horizontal cross-sectional shape whose surface has a curvature somewhat smaller than that of the spherical surface constituting the surface of the projection lens portion 3044Bs, and a front focus point in a horizontal plane thereof is located somewhat on the lamp front side relative to the rear focus point F of the projection lens portion 3044Bs.

As a result, in the left region 3042BL of the rear lens array 3042B, the light emitted from each projection lens portion 3044Bs is somewhat diffused in the horizontal direction substantially leftward relative to the optical axis Ax. In the right region 3042BR of the rear lens array 3042B, the light emitted from each projection lens portion 3044Bs is somewhat diffused in the horizontal direction substantially rightward relative to the optical axis Ax.

As shown in (c) of FIG. 34, the condenser lens portion 3042Cs of the rear lens array 3042C has an arc-shaped horizontal cross-sectional shape whose surface has a curvature considerably smaller than that of the spherical surface constituting the surface of the projection lens portion 3044Cs, and a front focus point in a horizontal plane thereof is located considerably on the lamp front side relative to the rear focus point F of the projection lens portion 3044Cs.

As a result, in the left region 3042CL of the rear lens array 3042C, the light emitted from each projection lens portion 3044Cs is largely diffused in the horizontal direction substantially leftward relative to the optical axis Ax. In the right region 3042CR of the rear lens array 3042C, the light emitted from each projection lens portion 3044Cs is largely diffused in the horizontal direction substantially rightward relative to the optical axis Ax.

FIG. 37 transparently shows a low-beam light distribution pattern PL1 formed by light irradiated from the vehicle lamp 3010 on a virtual vertical screen arranged at a position 25 m ahead of the vehicle.

The low-beam light distribution pattern PL1 is a low-beam light distribution pattern of left light distribution, and an upper end edge thereof has the cut-off lines CL1 and CL2.

The cut-off lines CL1 and CL2 are formed as an inverted projection image of the lower end edge 50a1 of each of the plurality of opening portions 3050a formed in the light shielding plate 3050.

The low-beam light distribution pattern PL1 is formed as a combined light distribution pattern in which six light distribution patterns PA2, PA3, PB2, PB3, PC2, and PC3 are superimposed.

The two light distribution patterns PA2 and PA3 are light distribution patterns formed by light irradiated from the lamp unit 3320A, and are formed to surround the elbow point E as small, bright and laterally long light distribution patterns. In this case, the two light distribution patterns PA2 and PA3 are formed in a state of partially overlapping with each other with the line V-V serving as a center. As a result, a high luminous intensity region of the low-beam light distribution pattern PL1 is formed.

The light distribution pattern PA2 is a small and bright light distribution pattern formed by light transmitted through the left region 3042AL of the rear lens array 3042A. A center of the light distribution pattern PA2 is displaced leftward relative to the line V-V. This is because the light transmitted through the left region 3042AL is emitted from the front lens array 3044A as light slightly diffused in the horizontal direction substantially leftward relative to the optical axis Ax.

The light distribution pattern PA3 is a small and bright light distribution pattern formed by light transmitted through the right region 3042AR of the rear lens array 3042A. A center of the light distribution pattern PM is displaced rightward relative to the line V-V. This is because the light transmitted through the right region 3042AR is emitted from the front lens array 3044A as light slightly diffused in the horizontal direction substantially rightward relative to the optical axis Ax.

The two light distribution patterns PB2 and PB3 are light distribution patterns formed by light irradiated from the lamp unit 3320B, and are formed as laterally long light distribution patterns that are slightly larger than the two light distribution patterns PA2 and PMA3. In this case, the two light distribution patterns PB2 and PB3 are formed in a state of partially overlapping with each other with the line V-V serving as a center. As a result, an intermediate diffusion region of the low-beam Light distribution pattern PL1 is formed.

The light distribution pattern PB2 is a light distribution pattern having a medium size formed by light transmitted through the left region 3042BL of the rear lens array 3042B. A center of the light distribution pattern PB2 is displaced leftward relative to the line V-V This is because the light transmitted through the left region 3042BL is emitted from the front lens array 3044B as light somewhat diffused in the horizontal direction substantially leftward relative to the optical axis Ax.

The light distribution pattern PB3 is a light distribution pattern having a medium size formed by light transmitted through the right region 3042BR of the rear lens array 3042B. A center of the light distribution pattern PB3 is displaced rightward relative to the line V-V. This is because the light transmitted through the right region 3042BR is emitted from the front lens array 3044B as light somewhat diffused in the horizontal direction substantially rightward relative to the optical axis Ax.

The two light distribution patterns PC2 and PC3 are light distribution patterns formed by light irradiated from the lamp unit 3020C, and are formed as laterally long light distribution patterns that are further slightly larger than the two light distribution patterns PB2 and PB3. In this case, the two light distribution patterns PC2 and PC3 are formed in a state of partially overlapping with each other with the line V-V serving as a center. As a result, a high diffusion region of the low-beam light distribution pattern PL1 is formed.

The light distribution pattern PC2 is a large light distribution pattern formed by light transmitted through the left region 3042CL of the rear lens array 3042C. A center of the light distribution pattern PC2 is displaced leftward relative to the line V-V. This is because the light transmitted through the left region 3042CL is emitted from the front lens array 3044C as light largely diffused in the horizontal direction substantially leftward relative to the optical axis Ax.

The light distribution pattern PC3 is a large light distribution pattern formed by light transmitted through the right region 3042CR of the rear lens array 3042C. A center of the light distribution pattern PC3 is displaced rightward relative to the line V-V. This is because the light transmitted through the right region 3042CR is emitted from the front lens array 3044C as light largely diffused in the horizontal direction substantially rightward relative to the optical axis Ax.

Next, an operation of the present embodiment will be described.

The vehicle lamp 3010 according to the present embodiment includes the three lamp units 3020A, 3020B, and 3020C. The three lamp units 3020A to 3020C are configured to form the required light distribution pattern by irradiating the light emitted from the light source unit 30 toward the lamp front side via the microlens arrays 3040A, 3040B and 3040C. Since the light shielding plate 3050 configured to define the shape of each of the plurality of light source images formed by the plurality of condenser lens portions 3042As, 3042Bs and 3042Cs is arranged between the rear lens arrays 3042A, 3042B and 3042C and the front lens arrays 3044A, 3044B and 3044C constituting the microlens arrays 3040A to 3040C, the low-beam light distribution pattern PL1 whose upper portion has the horizontal and oblique cut-off lines CL1 and CL2 can be formed as the required light distribution pattern.

In addition, since the optical axes Axa2, Axb2 and Axc2 of the condenser lens portions 3042As to 3042Cs of the rear lens arrays 3042A to 3042C are offset relative to the optical axes Axa4, Axb4 and Axc4 of the corresponding projection lens portions 3044As, 3044Bs and 3044Cs, a proportion of the light shielded by the light shielding plate 3050 to the light which is emitted from the light source unit 30 and incident on the rear lens arrays 3042A to 3042C can be reduced, and thus a light source light flux can be effectively used. Therefore, the low-beam light distribution pattern PL1 can be formed with increased brightness while positions and shapes of the horizontal and oblique cut-off lines CL1 and CL2 are maintained

As described above, according to the present embodiment, the vehicle lamp 3010 including the microlens arrays 3040A to 30400 can sufficiently ensure the brightness of the light distribution pattern even when the light distribution pattern having the cut-off lines is formed.

In this case, since the optical axes Axa2 to Axc2 of the condenser lens portions 3042As to 3042Cs of the rear lens arrays 3042A to 3042C are offset upward relative to the optical axes Axa4 to Axc4 of the corresponding projection lens portions 3044As to 3044Cs, the brightness can be sufficiently ensured even when the low-beam light distribution pattern PL1 whose upper portion has the horizontal and oblique cut-off lines CL1 and CL2 is formed.

In addition, since the amounts of the upward offset of the optical axes Axa2 to Axc2 of the condenser lens portions 3042As to 3042Cs of the three rear lens arrays 3042A to 3042C are different, the low-beam light distribution pattern PL1 can be formed as the combined light distribution pattern of the three sets of light distribution patterns PA2, PA3, PB2, PB3, PC2, and PC3 whose lower end edge positions are different. As a result, the low-beam light distribution pattern PL1 can be formed with less light distribution unevenness.

In addition, since the optical axes Axa2 to Axc2 of the condenser lens portions 3042As to 3042Cs of the rear lens arrays 3042A to 3042C are offset in the left-right direction relative to the optical axes Axa4 to Axc4 of the corresponding projection lens portions 3044As to 3044Cs, the low-beam light distribution pattern PL1 can be formed with increased left-right direction spread while the positions and the shapes of the horizontal and oblique cut-off lines CL1 and CL2 are maintained.

In this case, since the rear lens arrays 3042A to 3042C includes a plurality of regions in which the amounts of the left-right direction offset of the optical axes Axa2 to Axc2 of the condenser lens portions 3042As to 3042Cs are different from each other (specifically, the left-right direction offset of the left regions 3042AL, 3042BL, and 3042CL and the right regions 3042AR, 3642BR, and 3042CR of the rear lens arrays 3042A to 3042C are opposite to each other), the low-beam light distribution pattern PL1 can be formed as the combined light distribution pattern of the three sets of light distribution patterns PA2, PA3, PB2, PB3, PC2, and PC3 whose left-right direction positions are offset from each other. As a result, the low-beam light distribution pattern PL1 can be formed with still less light distribution unevenness.

Further, since the front focus points of the condenser lens portions 3042As to 3042Cs of the rear lens arrays 3042A to 3042C are offset to the lamp front side relative to the rear focus points F of the corresponding projection lens portions 3044As to 3044Cs, a light source image having a constant size is formed on each rear focal plane of each of the projection lens portions 3044As to 3044Cs by the light which is emitted from the light source unit 30 and is incident on the rear lens arrays 3042A to 3042C. As a result, a size of the low-beam light distribution pattern PL1 can be increased.

In addition, in the present embodiment, since the amount of the offset to the lamp front side relative to the projection lens portions 3044As, 3044Bs, and 3044Cs increases in the order of the condenser lens portions 3042As, 3042Bs, and 3042Cs, the light distribution patterns PA2 and PA3 formed by the transmitted light of the rear lens array 3042A can be formed as the small and bright light distribution patterns, the light distribution patterns PB2 and PB3 formed by the transmitted light of the rear lens array 3042B can be formed as slightly larger light distribution patterns whose brightness is decreased, and the light distribution patterns PC2 and PC3 formed by the transmitted light of the rear lens array 3042C can be formed as further larger light distribution patterns whose brightness is further decreased. As a result, the low-beam light distribution pattern PL1 can provide excellent visibility of a traveling path ahead of the vehicle.

Although the optical axes Axa2 to Axc2 of the condenser lens portions 3042As to 3042Cs are offset upward relative to the optical axes Axa4 to Axc4 of the corresponding projection lens portions 3044As to 3044Cs over an entire region of each of the rear lens arrays 3042A to 3042C in the above embodiment, a configuration in which the upward offset is only present in a part of the region may also be adopted.

Although the left-right direction offsets are opposite in the left regions 3042AL to 3042CL and the right regions 3042AR to 3042CR of the rear lens arrays 3042A to 3042C in the above embodiment. the offsets may also be in the same direction. It is also possible to provide regions having different amounts of left-right direction offset in the respective left regions 3042AL to 3042CL and/or the respective right regions 3042AR to 3042CR.

Although the three lamp units 3020A to 3020C are provided, and the light distribution patterns having different sizes are formed by each of the lamp units 3020A to 3020C in the above embodiment, other configurations (for example a configuration in which a plurality of light distribution patterns having different sizes are formed by a single lamp unit) may also be adopted.

Although the condenser lens portions 3042As to 3042Cs of the rear lens arrays 3042A to 3042C and the projection lens portions 3044As to 3044Cs of the front lens arrays 3044A to 3044C are allocated to each of the plurality of segments divided in the vertical and horizontal grid pattern in the third embodiment, it is also possible to adopt a division other than the vertical and horizontal grid pattern (for example, a division of an diagonal grid pattern).

### Modification of Fourth Embodiment

Next, a modification of the fourth embodiment will be described.

FIG. 38 shows a vehicle lamp 3110 according to the present modification in the same manner as FIG. 33.

As shown in FIG. 38, a basic configuration of the present modification is the same as that of the fourth embodiment, except that a single lamp unit 3120D is provided, and an additional light distribution pattern of a high-beam light distribution pattern (that is, a light distribution pattern formed in addition to the low-beam light distribution pattern) is formed by light irradiated from the lamp unit 3120D, which is partially different from the fourth embodiment.

In order to realize such a configuration, a basic configuration of the lamp unit 3120D of the present modification is similar to that of the lamp unit 3020A of the above-described embodiment, while a configuration of a rear lens array 3142D of a microlens array 3140D and a configuration of a light shielding plate 3150 are partially different from those of the fourth embodiment.

That is, although the rear lens array 3142D of the present modification still has a configuration in which a plurality of condenser lens portions 3142Ds1 and 3142Ds2 configured to converge the light emitted from the light source unit 30 are formed on a rear surface, an optical axis Axd2 of each of the condenser lens portions 3142Ds1 and 3142Ds2 is offset downward relative to the optical axis Axa4 of each of the corresponding projection lens portions 3044As.

A surface of each of the condenser lens portions 3142Ds1 and 3142Ds2 is formed with an arc-shaped vertical cross-sectional shape whose curvature is smaller than that of the spherical surface constituting the surface of the projection lens portion 3044As, and a front focus point in a vertical plane thereof is located on the lamp front side relative to the rear focus point F of the projection lens portion 3044As.

In this case, each condenser lens portion 3142Ds2 formed in a lower region 3142D2 below the optical axis Ax of the light source unit 30 of the rear lens array 3142D is formed with an arc-shaped vertical cross-sectional shape whose curvature is smaller than each condenser lens portion 3142Ds1 formed in an upper region 3142D1 above the optical axis Ax. As a result, transmitted light of the lower region 3142D2 has a larger up-down direction spread when emitted from the projection lens portion 3044As as compared with transmitted light of the upper region 3142D1.

A horizontal cross-sectional shape of each of the condenser lens portions 3142Ds1 and 3142Ds2 is formed with a smaller curvature than the vertical cross-sectional shape thereof As a result, when the transmitted light of the upper region 3142D1 and the transmitted light of the lower region 3142D2 are both emitted from the projection lens portion 3044As, a left-right direction spread thereof is larger than the up-down direction spread.

The light shielding plate 3150 of the present modification is also formed of a thin plate in which a plurality of opening portions 3150a are regularly formed. The plurality of opening portions 3150a are arranged in the vertical and horizontal grid pattern so as to correspond to the plurality of projection lens portions 3044As of the front lens array 3044A. However, an upper end edge 3150a2 of the opening portion 3150a of the light shielding plate 3150 shields a part of the light from the light source unit 30 that has reached the light shielding plate 3150 via the condenser lens portions 3142Ds1 and 3142Ds2, so that a light source image whose upper end portion has a light-shade boundary line is formed on the rear focal plane of the projection lens portion 3044As.

In this case, since the optical axis Axd2 of each of the condenser lens portions 3142Ds1 and 3142Ds2 is offset downward relative to the optical axis Axa4 of the projection lens portion 3044As, an amount of light shielded by the light shielding plate 3150 is reduced as compared with a case where the downward offset is not present, and thus a bright light source image is formed.

FIG. 39 transparently shows an additional light distribution pattern PD formed by light irradiated from the vehicle lamp 3110 on a virtual vertical screen arranged at a position 25 m ahead of the vehicle.

The additional light distribution pattern PD is a light distribution pattern formed in addition to the low-beam light distribution pattern PL1 (see FIG. 37) indicated by a broken line in the drawing, and the high-beam light distribution pattern PH is formed as a combined light distribution pattern thereof.

The additional light distribution pattern PD is formed as a laterally long light distribution pattern centered on the line V-V. A lower portion of the additional light distribution pattern PD has a horizontal cut-off line CL3.

The horizontal cut-off line CL3 is formed as an inverted projection image of an upper end edge 3150a2 of the plurality of opening portions 3150a formed in the light shielding plate 3150, and a position thereof is set by a position where the upper end edge 3150a2 is formed. In the present modification, the horizontal cut-off line CL3 is located slightly below the horizontal cut-off line CL1 of the low-beam light distribution pattern PL1 (specifically, below the line H-H by about 1° to 2°).

The additional light distribution pattern PD is formed as a combined light distribution pattern of two light distribution patterns PD1 and PD2.

The light distribution pattern PD1 is a light distribution pattern formed by light transmitted through the plurality of condenser lens portions 3142Ds1 located in the upper region 3142D1 of the rear lens array 3142D, and is formed as a small and bright light distribution pattern.

The light distribution pattern PD2 is a light distribution pattern formed by light transmitted through the plurality of condenser lens portions 3142Ds2 located in the lower region 3142D2 of the rear lens array 3142D, and is formed as a light distribution pattern which is darker and relatively larger than the light distribution pattern PD1.

In the present modification, the additional light distribution pattern PD is additionally formed so as to partially overlap the low-beam light distribution pattern PL, so that a light distribution pattern having a high luminous intensity region in the vicinity of H-V can be formed as the high-beam light distribution pattern PH.

At this time, since the lower portion of the additional light distribution pattern PD has the horizontal cut-off line CL3, it is possible to only brightly irradiate a distant region without irradiating a close region on the traveling path ahead of the vehicle. As a result, the high-beam light distribution pattern PH can provide excellent distant visibility

Numerical values shown as specifications in the above embodiments and the modifications thereof are merely examples, and these values may be set to different values as appropriate.

The present disclosure is not limited to the configurations described in the above embodiments and the modifications thereof, and a configuration added with various other changes may be adopted.

The present application is based on Japanese Patent Application No. 2018-190500, 2018-190501, and 2018-190502 filed on Oct. 5, 2018 and Japanese Patent Application No. 2018-207297 filed on Nov. 2, 2018, the contents of which are incorporated herein as reference.

1. A vehicle lamp configured to form a required light distribution pattern by irradiating light emitted from a light source unit toward a lamp front side via a microlens array, wherein the microlens array is configured such that a plurality of condenser lens portions configured to converge the light emitted from the light source unit are formed on a rear surface, while a plurality of projection lens portions configured to project a plurality of light source images formed by the plurality of condenser lens portions are formed on a front surface, and a laterally long light distribution pattern is formed by the light emitted from the microlens array.

2. The vehicle lamp according to claim 1, wherein the microlens array includes a region in which a curvature of a surface of the condenser lens portion and/or the projection lens portion is set to different values in a horizontal plane and in a vertical plane.

3. The vehicle lamp according to claim 1, wherein the microlens array includes a region in which a curvature in a horizontal plane of a surface of the condenser lens portion and a curvature in a horizontal plane of a surface of the projection lens portion corresponding to the condenser lens portion are set to different values.

4. The vehicle lamp according to claim 1, wherein the microlens array includes a region in which a horizontal cross-sectional shape of a surface of the projection lens portion has a concave curved shape.

5. The vehicle lamp according to claim 1, wherein the microlens array includes a region configured to cause incident light from the condenser lens portion to be incident on projection lens portions adjacent to left and right sides of the projection lens portion corresponding to the condenser lens portion.

6. The vehicle lamp according to claim 1, wherein the microlens array includes a region in which outer shapes of the condenser lens portion and the projection lens portion corresponding to the condenser lens portion are set to a vertically long rectangular shape in a lamp front view.

7-10. (canceled)

11. A vehicle lamp configured to form a required light distribution pattern by irradiating light emitted from a light source unit toward a lamp front side via a microlens array, wherein the microlens array includes a rear lens array in which a plurality of condenser lens portions configured to converge the light emitted from the light source unit are formed on a rear surface, and a front lens array in which a plurality of projection lens portions configured to project a plurality of light source images formed by the plurality of condenser lens portions are formed on a front surface, and
a light shielding plate configured to define a shape of each of the plurality of light source images and a color filter configured to change a color of the light emitted from the microlens array to a color different from a color of the light emitted from the light source unit are arranged between the rear lens array and the front lens array.

12. The vehicle lamp according to claim 11, wherein the color filter is constituted by a color film attached to the light shielding plate.

13. The vehicle lamp according to claim 11, wherein the light shielding plate and the color filter are sandwiched by the front lens array and the rear lens array from two sides in a lamp front-rear direction.

14. The vehicle lamp according to claim 11, wherein in the rear lens array, an optical axis of the condenser lens portion is offset upward relative to an optical axis of the projection lens portion corresponding to the condenser lens portion.

15. The vehicle lamp according to claim 11, wherein in the rear lens array, a front focus point of the condenser lens portion is offset to the lamp front side relative to a rear focus point of the projection lens portion corresponding to the condenser lens portion.

16. A vehicle lamp configured to form a required light distribution pattern by irradiating light emitted from a light source unit toward a lamp front side via a microlens array, wherein
the microlens array includes a rear lens array in which a plurality of condenser lens portions configured to converge the light emitted from the light source unit are formed on a rear surface, and a front lens array in which a plurality of projection lens portions configured to project a plurality of light source images formed by the plurality of condenser lens portions are formed on a front surface,
a light shielding plate configured to define a shape of each of the plurality of light source images is arranged between the rear lens array and the front lens array, and
the rear lens array includes a region in which an optical axis of the condenser lens portion is offset relative to an optical axis of the projection lens portion corresponding to the condenser lens portion.

17. The vehicle lamp according to claim 16, wherein the rear lens array includes a region in which the optical axis of the condenser lens portion is offset upward relative to the optical axis of the projection lens portion corresponding to the condenser lens portion.

18. The vehicle lamp according to claim 17, wherein the rear lens array includes a plurality of regions in which amounts of upward offset of the optical axis of the condenser lens portion are set to different values.

19. The vehicle lamp according to claim 16, wherein the rear lens array includes a region in which the optical axis of the condenser lens portion is offset in a left-right direction relative to the optical axis of the projection lens portion corresponding to the condenser lens portion.

20. The vehicle lamp according to claim 19, wherein the rear lens array includes a plurality of regions in which amounts of the left-right direction offset of the optical axis of the condenser lens portion are set to different values.

21. The vehicle lamp according to claim 19, wherein the rear lens array includes a region in which a front focus point of the condenser lens portion is offset to the lamp front side relative to a rear focus point of the projection lens portion corresponding to the condenser lens portion.
